(19) United States
(12) Patent Application Publication
(10) Pub. No.: US 2014/0052440 A1
(43) Pub. Date: Feb. 20, 2014

(54) CODING THROUGH COMBINATION OF CODE VECTORS

(71) Applicants: Adriana Vasilache, Tampere (FI); Lasse Vaaksonen, Nokia (FI); Anssi Rämö, Tampere (FI); Mikko Tammi, Tampere (FI)

(72) Inventors: Adriana Vasilache, Tampere (FI); Lasse Vaaksonen, Nokia (FI); Anssi Rämö, Tampere (FI); Mikko Tammi, Tampere (FI)

(73) Assignee: Nokia Corporation, Espoo (FI)

(21) Appl. No.: 13/981,709

(22) PCT Filed: Jan. 28, 2011
(86) PCT No.: PCT/IB11/50377

§ 371 Date: Aug. 27, 2013

(51) Int. Cl. G10L 19/038

(52) U.S. Cl. CPC G10L 19/038
USPC 704/230

(57) ABSTRACT

It is inter alia disclosed to determine a single code vector index based on combining at least two code vector indexes, each code vector index being associated with a code vector of a respective codebook.

### FIELD

Embodiments of this invention relate to coding, in particular to speech and audio coding.

### BACKGROUND

Low complexity algorithms for speech and audio coding constitute a very relevant asset, for instance for mobile terminal based communications. Due to low storage and low complexity, while preserving coding efficiency, structured codebooks may be preferred in several state of the art speech and audio codecs, like for instance the Enhanced Voice Service (EVS) codec to be standardized within the Third Generation Partnership Project (3GPP).

Codebooks used within these speech and audio codecs may for instance be based on lattice structures, as described in reference “Multiple-scale leader-lattice VQ with application to LSF quantization” by A. Vasilache, B. Dumitrescu and I. Tabus, Signal Processing, 2002, vol. 82, pages 563-586, Elsevier, which is incorporated herein in its entirety by reference.

It is possible to define a lattice codebook as a union of leader classes, each of which is characterized by a leader vector. A leader vector is an n-dimensional vector (with n denoting an integer number), whose (e.g. positive) components are ordered (e.g. decreasingly). The leader class corresponding to the leader vector then consists of the leader vector and all vectors obtained through all the signed permutations of the leader vector (with some possible restrictions). It is also possible that one, some or all leader classes are respectively associated with one or more scales, and the lattice codebook is then formed as a union of scaled and/or unscaled leader classes.

An input vector may for instance be encoded (for instance in quantization) by finding the nearest neighbor code vector in the codebook, i.e. the code vector that has the smallest distance with respect to the input vector. An identifier of this code vector (e.g. an index assigned to this code vector) then may serve as an encoded representation of the input vector.

For instance, a longer vector (e.g. from a time frame of a speech, audio or video signal) may be quantized. For general codebooks, it is customary that the number of code vectors is a power of two such that all the bits are used when addressing the code vectors. For unconstrained optimized codebooks this choice is not always a very constraining issue. When using for instance lattice codebooks or other codebooks with a predefined structure, the number of code vectors in the codebook can rarely be an exact power of two. Consequently, there is a loss in the coding efficiency. For the case when several code vectors should be encoded at a time, the present invention proposes the use of a combined single index for all the code vectors, making the coding more efficient.

### SUMMARY OF SOME EMBODIMENTS OF THE INVENTION

Although the use of structured codebooks already reduces the amount of memory and the computational complexity required for encoding an input vector, further reduction of the memory requirements and/or the computational complexity is desirable, for instance with respect to application of codebook-based encoding in mobile devices.

According to a first aspect of the invention, a method is disclosed, comprising determining a single code vector index based on combining at least two code vector indexes, each code vector index being associated with a code vector of a respective codebook.

According to a second aspect of the invention, an apparatus is disclosed, which is configured to perform the method according to the first aspect of the invention, or which comprises means for performing the method according to the first aspect of the invention, i.e. means for determining a single code vector index based on combining at least two code vector indexes, each code vector index being associated with a code vector of a respective codebook.

According to a third aspect of the invention, an apparatus is disclosed, comprising at least one processor and at least one memory including computer program code, the at least one memory and the computer program code configured to, with the at least one processor, cause the apparatus at least to perform the method according to the first aspect of the invention. The computer program code included in the memory may for instance at least partially represent software and/or firmware for the processor. Non-limiting examples of the memory are a Random-Access Memory (RAM) or a Read-Only Memory (ROM) that is accessible by the processor.

According to a fourth aspect of the invention, a computer program is disclosed, comprising program code for performing the method according to the first aspect of the invention when the computer program is executed on a processor. The computer program may for instance be distributable via a network, such as for instance the Internet. The computer program may for instance be storable or encodable in a computer-readable medium. The computer program may for instance at least partially represent software and/or firmware of the processor.

According to a fifth aspect of the invention, a computer-readable medium is disclosed, having a computer program according to the fourth aspect of the invention stored thereon. The computer-readable medium may for instance be embodied as an electric, magnetic, electro-magnetic, optic or other storage medium, and may either be a removable medium or a medium that is fixedly installed in an apparatus or device. Non-limiting examples of such a computer-readable medium are a RAM or ROM. The computer-readable medium may for instance be a tangible medium, for instance a tangible storage medium. A computer-readable medium is understood to be readable by a computer, such as for instance a processor.

In the following, features and embodiments pertaining to all of these above-described aspects of the invention will be briefly summarized.

For instance, there may exist at least one codebook, wherein each of the at least one codebook is associated with a code vector leader class comprising at least one code vector, wherein a code vector index of the at least two code vector indexes is associated with a code vector of the respective codebook, and wherein said respective codebook is one of the at least one codebook. Accordingly, a code vector index of the at least two code vector indexes is associated with a respective codebook.

At least two code vector indexes maybe provided, wherein each of the at least two code vector indexes represents a code vector of a respective codebook. As an example, the at least two code vector indexes may be associated with different codebooks, i.e., the at least one codebook represents at least two codebooks, wherein a first code vector index of the at least two code vector indexes is associated with a first codebook of the at least two codebooks, and wherein a second code index of the at least two code vector indexes is associated with a second codebook of the at least two codebooks, the second codebook being different from the first codebook. Or, for instance, a first code vector index of the at least two code vector indexes is associated with a same codebook as a second code vector index of the at least two code vector indexes, wherein, as an example, the first code vector index may be associated with a code vector of this codebook and the second code vector index of this codebook may be associated with another or the same code vector of this codebook.

The single code vector index may be considered as a representative of the at least two code vector indexes. The combining may represent any suited mathematical operation in order to determine the single code vector index. Thus, the single code vector index comprises information on each of the at least two code vector indexes. The information on each of the at least two code vector indexes may be extracted from the single code vector index. Accordingly, at least one or each of the at least two code vectors associated with the single code vector indexes can be extracted from the single code vector index. Afterwards, for each of the extracted code vector index the respective code vector in the respective codebook can be obtained. For instance, the code vector index may comprise information about the respective codebook, or, the code vector index may not comprise information about the respective codebook. In the latter case, as an example, a separate information being indicative of the respective codebook associated with each of the at least two code vector indexes may be obtained and may be provided at an encoder.

For instance, the single code vector index may represent a value and each of the at least two code vector indexes may represent a value. The values of the at least two code vector indexes may be combined by means of an invertible mathematical operation, wherein invertible may be understood in a manner that at least one code vector index of the at least two code vector indexes can be extracted from the single code vector index.

The single code vector index may be in a binary representation. For instance, as a non-limiting example, a code vector index may be represented by an integer value in range from 0 to Nₖ−1, wherein Nₖ may represent the size of the respective codebook. Other representations may also be applied to represent the code vector index.

According to an exemplary embodiment of all aspects of the invention, said single code vector index is associated with a combined code vector of a combined codebook, wherein said combined code vector comprises information on the at least two code vectors and wherein said combined codebook is based on a combination of the codebooks associated with the at least two code vector indexes.

As an example, the single code vector index may be associated with a combined code vector of a combined codebook. This combined code vector may comprise information on the at least two code vectors. Furthermore, the combined codebook may be based on a combination of the codebooks associated with the at least two code vector indexes.

For instance, n may represent the numbers of the at least two code vector indexes, and the combined codebook may comprise a plurality of combined code vectors, wherein each of the combined code vectors may be a representation of a combination of one code vector cₖ of each respective codebook Cₖ (wherein k in 0 . . . n−1 holds) being associated with a respective code vector index of the at least two code vector indexes I₀ . . . Iₙ₋₁. For instance, a combined code vector may be a representation of a combination of c₀, c₁, . . . , cₖ₋₁, wherein cₖ (wherein k in 0 . . . n−1 holds) is a code vector of the respective kth codebook cₖ.

For instance, in case the ith code vector index of the at least two code vector indexes is associated with a respective codebook Cᵢ comprising Nᵢ code vectors, the combined codebook may comprise N₀· . . . ·Nₙ₋₁ code vectors due to the possible number of permutations.

The usage of this combined codebook may lead to a lower number of bits when quantizing the at least two code vector indexes. If each of the at least two code vector indexes would be quantized in the respective codebook the number of bits to encode the n (where n is an integer and n>1 holds) code vectors is

$${\sum }_{k = 0}^{n - 1} ceil ( {log}_{2} ( {N}_{k} ) ) \qquad ( 1 )$$

where the ceil function gives the closest higher integer.

If the n code vectors are coded together by considering the combined codebook of N₀· . . . ·Nₙ code vectors the number of bits is

$$ceil ( {\sum }_{k = 0}^{n - 1} {log}_{2} ( {N}_{k} ) ) \qquad ( 2 )$$

which may give a lower number of bits for the same quantization distortion, i.e.,

$$ceil ( {\sum }_{k = 0}^{n - 1} {log}_{2} ( {N}_{k} ) ) \leq {\sum }_{k = 0}^{n - 1} ceil ( {log}_{2} ( {N}_{k} ) ) \qquad ( 3 )$$

holds.

The single code vector index may be provided, for instance to another component via the I/O output, or internally to another process of program executed by the processor. Alternatively or additionally, further processing based on the single code vector index.

For instance, the single code vector index may be denoted as I, and the at least two code vector indexes may represent n code vector indexes, i.e., integer n>1 holds, wherein a code vector index of said n code vector indexes may be denoted as Iₖ, wherein k in 0 . . . n−1 holds. Each code vector index Iₖ is associated with a code vector of a respective codebook Cₖ, wherein this codebook Cₖ comprises Nₖ code vectors.

As a non-limiting example, the single code vector index may be obtained by the following equation which performs an example of the combining of at least two code vector indexes, Iₖ, wherein k in 0 . . . n−1 holds, each of the code vector indexes Iₖ being associated with a code vector of a respective code book Cₖ:

$$I = {\sum }_{k = 0}^{n - 1} ( {I}_{k} \cdot {\prod }_{l = 0}^{k - 1} {N}_{l} ) = {I}_{0} + {N}_{0} \cdot {I}_{1} + … + {N}_{0} \cdot … \cdot {N}_{n - 2} \cdot {I}_{n - 1} \qquad ( 4 )$$

For instance, the order in which the codebooks of the at least two codevectors are taken depends on the codebook sizes, wherein smaller codebooks having a smaller size are chosen first in accordance with the order. For example, a corresponding representation for deriving the index in accordance with the selected order of codebooks is derived. For instance, this representation may be a formula or a look-up table or the like. As an example, this representative may be transmitted or provided. Thus, the complexity of forming the index in accordance with equation (9) may be lower, since less operations with big numbers will be performed.

According to an exemplary embodiment of all aspects of the invention, at least one vector is splitted into at least two subvectors and an encoding is performed on each of at least two of the at least two subvectors, wherein said encoding comprises for each of at least two subvectors of the at least two subvectors: Determining a code vector in a respective codebook, and providing a code vector index of the determined code vector, the provided code vector index being one of the at least two code vector indexes.

For instance, said vector may at least partially represent at least one of a video, image, audio and speech signal.

Each of the at least one vector may comprise a plurality of coefficients. Each of the at least one subvector comprises at least one coefficient.

This at least one vector may represent any at least one vector comprising data to be encoded. This at least one vector may for instance be obtained by reception, or may be internally obtained from a process or program that is executed by the processor. This process of program may for instance be part of an encoding process. The at least one vector may for instance be representative of at least a part of a speech, audio, image and/or video signal. The at least one vector may for instance comprise differential spectral data or Line Spectral Frequency (LSF) coefficients of a speech signal, to name but a few examples.

For instance, as a non-limiting example, this at least one vector may represent a vector obtained during an Adaptive Multi-Rate (AMR)—Wideband (WB) encoding, wherein a Modified Discrete Cosine Transformation (MDTC) is performed on a difference signal and the transform coefficients are encoded. For instance, encoding of these transform coefficients for a bitstream may include encoding a vector comprising a plurality of coefficients with a predetermined amount of bits per bitstream.

Then, an encoding is performed for at least two subvectors of the at least two subvectors. The encoding may be performed by means of at least one codebook, wherein each of the at least one codebook comprises at least one code vector. Each of the at least two subvectors of the at least two subvectors is encoded with a codevector from one of the at least one codebook. For instance, the nearest codevector from at least one codevector of a codebook of the at least one codebook may be selected for encoding a respective subvector, or the nearest codevector from a plurality of codevectors may be selected for encoding a respective subvector, wherein the plurality of codevectors may represent at least two subvectors from at least two codebooks.

According to an exemplary embodiment of all aspects of the invention, said encoding comprises for each of the at least two subvectors of the at least two subvectors: Determining a codebook of at least two codebooks, each of the at least two codebooks being associated with a respective leader class and comprising at least one code vector; and providing the determined codebook for said determining the code vector in a respective codebook.

Thus, for each of the at least two subvectors a code vector may be determined in a respective codebook of the at least one codebook, and a code vector index of the determined code vector is provided for the respective subvector. In case the at least one codebook represents a plurality of codebooks, an indicator of the selected codebook may be provided.

Accordingly, the encoding results in at least two code vector indexes, wherein each of the at least two code vector indexes is associated with a respective codevector in a respective codebook of the at least one codebook.

Furthermore, for instance, as non-limiting example, it is possible to define a lattice codebook as a union of leader classes, each of which is characterized by a leader vector.

Codebooks used within these speech and audio codecs may for instance be based on lattice structures, as described in reference “Multiple-scale leader-lattice VQ with application to LSF quantization” by A. Vasilache, B. Dumitrescu and I. Tabus, Signal Processing, 2002, vol. 82, pages 563-586, Elsevier, which is incorporated herein in its entirety by reference.

A leader vector is an n-dimensional vector (with n denoting an integer number), whose (positive) components are ordered (e.g. decreasingly). The leader class corresponding to the leader vector then consists of the leader vector and all vectors obtained through all the signed permutations of the leader vector (with some possible restrictions). It is also possible that one, some or all leader classes are respectively associated with one or more scales, and the lattice codebook is then formed as a union of scaled and/or unscaled leader classes. For instance, a D10+ lattice may be considered for quantization, but any other well-suited lattice may also be considered.

A subvector may for instance be encoded/quantized by finding the nearest neighbor code vector in the codebook, i.e. the code vector that has the smallest distance with respect to the subvector. An identifier of this code vector (e.g. a codevector index assigned to this code vector) then may serve as a representation of the quantized subvector.

For instance, finding the nearest neighbor code vector in the codebook may comprise for each of the at least two subvectors identifying a leader vector of the plurality of leader vectors, the identified leader vector representing the nearest leader vector with respect to the respective subvector, and identifying the nearest code vector of the plurality of code vectors in the leader vector class associated with the identified leader vector. The identified leader vector for a respective subvector may be represented by a leader vector representation. This leader vector representation may for instance represent a leader vector index. Furthermore, the leader class of this identified leader vector may be considered to represent the respective codebook of the at least one codebook.

The codevector index within the leader vector class may for instance be obtained through an enumeration algorithm as described in reference WO 2009/100768 A1, which is incorporated herein by reference. The leader vector index may be encoded separately from the code vector indexes.

For instance, after a codevector has been determined for each of the at least two subvectors, it may be determined for each of the codevectors whether this codevector represents a null codevector or a non-null codevector. If a codevector represents a non-null codevector, the respective code vector index may be provided as one of the at least two code vector indexes used in any of the methods according to a first to fifth embodiment of the invention explained above. On the other hand, if a codevector represents a null codevector, the respective core vector index may not be provided as one of the at least two code vector indexes. Thus, the at least two code vector indexes used in any the methods according to a first to fifth embodiment of the invention may represent significant code vectors, whereas null codevectors are neglected.

According to an exemplary embodiment of all aspects of the invention, said at least one vector is associated with at least two stages of quantization.

Thus, the at least two codebooks associated with the single code vector index may be used in a multi-stage quantization comprising at least two stages of quantization. For instance, at each stage of the at least two stages the code vector indexes of the respective subvectors associated with the respective stage may be obtained, and the code vector indexes associated with the at least two stages may be combined to the single code vector index. Thus, there is no constraint that each stage should have a power of two code vectors.

As a non-limiting example, the at least one vector may represent at least two vectors, and each vector of the at least two vectors may be associated with a separate equalization stage.

According to an exemplary embodiment of all aspects of the invention, said combining comprises: Assigning a first code vector index of the at least two code vector indexes to the single code vector index; selecting a further code vector index of the at least two code vector indexes; mapping the selected code vector index to an enhanced code vector index representation, said enhanced code vector index representation taking into account the at least one codebook being associated with the actual single code vector index; and updating the single code vector index by combining the single code vector index with the enhanced code vector index representation.

A first code vector index of the at least two code vector indexes is assigned to the single code vector index. Thus, the actual single code vector index may represent the first code vector index. This first code vector index may be denoted as Iₖ, wherein k may represent a counter of a loop and wherein k=0 may hold when starting the loop. Furthermore, the single code vector index may be denoted as I, i.e., I=I₀ may hold during loop k=0.

The first code vector index Iₖ is associated with a code vector of a respective codebook Cₖ, wherein k=0 holds. Accordingly, the actual single code vector index is associated with this codebook Cₖ, wherein k=0 holds.

Then a further code vector index of the at least two code vector indexes is selected. For instance, this further code vector index may be denoted as Iₖ, wherein k may be incremented, i.e., k=1 may hold for this selection, e.g., in accordance with incrementing the loop counter k.

Afterwards, the selected code vector index Iₖ is mapped to an enhanced code vector representation. This enhanced code vector index representation takes into account the at least one codebook being associated with the actual single code vector index. Considering loop k, this at least one codebook being associated with the actual single code vector index represents the codebooks C_{O}, . . . , Cₖ₋₁.

According to an exemplary embodiment of all aspects of the invention, the enhanced code vector index representation is associated with an enhanced room of a size depending on the size of the codebook of the selected code vector index and on the size of each of the at least one codebook being associated with the actual single code vector index.

Thus, mapping the selected code vector index Iₖ to an enhanced code vector index representation may comprise transforming the selected code vector index Iₖ to this room.

For instance, if code vector index Iₖ is associated with a code vector of a respective codebook Cₖ, wherein this codebook Cₖ comprises Nₖ code vectors, the code vector index Iₖ may be considered to be associated with a room of size Nₖ, since there exist Nₖ different code vector indexes associated with codebook Cₖ. In other words, a representation of size Nₖ may be necessary for representing the code vector index Iₖ.

The size of each of the at least one codebook being associated with the actual single code vector index depends on the size Nₗ of codebook Cₗ for each l, wherein l in 0 . . . k−1 holds, respectively.

Accordingly, the enhanced room associated with the enhanced code vector index representation may provide sufficient room for each permutation of the code vectors c₀, . . . , cₗ, wherein cₗ (wherein l in 0 . . . k holds) is a code vector of the respective kth codebook Cₗ.

For instance, the enhanced code vector index representation may be denoted as Eₖ, wherein Eₖ=f(Iₖ, N₀ . . . Nₖ₋₁) may hold.

According to an exemplary embodiment of all aspects of the invention, said mapping the selected code vector index to an enhanced code vector index representation is based on a multiplication of the selected code vector index and a value depending on the size of each of the at least one codebook being associated with the actual single code vector index.

As an non-limiting example, said mapping the selected code vector index Iₖ to an enhanced code vector index representation Eₖ may be based on a multiplication of the selected code vector index Iₖ and a value depending on the size of each of the at least one codebook being associated with actual single code vector index, i.e., depending on the sizes N₀ . . . Nₖ₋₁. This value, which may denoted as V, under the assumption that k>2 holds, may represent a value being indicative of the size of the combined codebooks N₀ . . . Nₖ₋₁ being associated with the actual single code vector index, or, if k=1 holds, the value may be indicative of the size of the codebook N₀.

For instance, the enhanced code vector index representation Eₖ may represent a value in a number range which is greater than the number range of possible values of the actual single code vector index I. Said number range of possible values of the actual single code vector index I may be defined by the possible permutations of code vectors c₀, . . . , cₗ, of the code vector indexes associated with the actual single code vector index I, wherein l in 0 . . . k−1 holds.

For instance, with regard to example equation (4), the enhanced code vector index representation may be considered to be represented by

$${E}_{k} = {I}_{k} \cdot \underbrace{{\prod }_{l = 0}^{k - 1} {N}_{l}}_{V} k ∈ \{ 1 , … , n - 1 \} . \qquad ( 5 )$$

In this example, the value V depending on the size of each of the at least one codebook being associated with the single code vector index represents the multiplication of the size of the codebooks N₀ . . . Nₖ₋₁.

After the selected code vector index representation Iₖ is mapped to the enhanced code vector index representation Eₖ, the single code vector representation is updated by combining the single code vector index with the enhanced code vector index representation.

Accordingly, after this combining, the single code vector representation I comprises information on each code vector index Iₗ, wherein l in 0 . . . k holds. Thus, I=f(I, Eₖ) may hold, wherein function f represents a function for updating the single code vector based on the enhanced code vector index representation Eₖ. Said combining may represent any well suited mathematical operation.

As a non-limiting example, this combining may be performed by an addition of the actual single code vector representation and the enhanced code vector index Eₖ:

I=I+Eₖ (6)

According to an exemplary embodiment of all aspects of the invention, after the updating, it is checked whether there is a further code vector index of the at least two code vector indexes, and, if this checking yields a positive result, this further code vector index is selected and proceeding with said mapping and updating.

After updating the single code vector index is performed as mentioned above, it is checked whether there is a further code vector index of the at least two code vector indexes. If this checking yields a positive result, this further code vector index is selected and it continues with mapping the selected code vector index to an enhanced vector representation and updating the single code vector index as explained above. Thus, the counter k may be incremented if the checking yields a positive result and the selected code vector index may be denoted as Iₖ.

Accordingly, in this way a loop may be passed through until there is no further code vector index to be combined on the single code vector index. Then it may be stopped.

According to an exemplary embodiment of all aspects of the invention, said combining comprises: Assigning a first code vector index of the at least two code vector indexes to the single code vector index; selecting a further code vector index of the at least two code vector indexes; transforming the single code vector index to a representation being associated with an enhanced room of a size depending on the size of the codebook of the selected code vector index and on the size of each of the at least one codebook being associated with the actual single code vector index; and updating the single code vector index by combining the transformed single code vector index with the selected code vector index.

A first code vector index of the at least two code vector indexes is assigned to the single code vector index. Thus, the actual single code vector index may represent the first code vector index. This first code vector index may be denoted as Iₖ, wherein k may represent a counter of a loop and wherein k=0 may hold when starting the loop. Furthermore, the single code vector index may be denoted as I, i.e., I=I₀ may hold during loop k=0.

The first code vector index Iₖ is associated with a code vector of a respective codebook Cₖ, wherein k=0 holds. Accordingly, the actual single code vector index is associated with this codebook Cₖ, wherein k=0 holds.

Then a further code vector index of the at least two code vector indexes is selected. For instance, this further code vector index may be denoted as Iₖ, wherein k may be incremented, i.e., k=1 may hold for this selection, e.g., in accordance with incrementing the loop counter k.

After the further code vector index Iₖ is selected, the single code vector index I is transformed to a representation being associated with an enhanced room, the size of this enhanced depending on the size of the codebook of the selected code vector index Iₖ and on the size of each of the at least one codebook being associated with the actual single code vector index I.

Accordingly, the enhanced room associated with the transformed representation of the single code vector index may provide sufficient room for each permutation of the code vectors c₀, . . . , cₗ, wherein cₗ (wherein l in 0 . . . k holds) is a code vector of the respective lth codebook Cₖ.

When k=1 may hold, the single code vector index I is only associated with the first code vector index I₀, wherein the first code vector index is associated with the codebook C₀. Thus, the single code vector index I is associated with a room corresponding to the size of codebook C₀, i.e., size N₀. Then, the single code vector index I is transformed to a representation being associated with an enhanced room of a size depending on the size Nₖ of the codebook of the selected code vector index and on the size N₀ of the at least one codebook being associated with the actual single code vector index.

According to an exemplary embodiment of all aspects of the invention, said transforming the single code vector representation is based on a multiplication of the actual single code vector index and a value depending on the size the codebook being associated with the selected code vector index.

Thus, this transformation may be performed by means of multiplying the single code vector index I with a value depending on the size Nₖ of the codebook being associated with the selected code vector index Iₖ, i.e.,

I=I·Nₖ (7)

may hold.

Afterwards, the single code vector index I, which is in the representation being associated with the enhanced room, is updated by combining the transformed single code vector index I with the selected code vector index Iₖ.

Accordingly, after this combining, the single code vector representation I comprises information on each code vector index Iₗ, wherein l in 0 . . . k holds. Thus, I=f(I, Iₖ) may hold, wherein function f represents a function for updating the single code vector based on the transformed single code vector index I and the selected code vector index Iₖ. Said combining may represent any well suited mathematical operation.

For instance, said combining may be performed by an addition:

I=I+Iₖ (8)

According to an exemplary embodiment of all aspects of the invention, after the updating is performed, it is checked whether there is a further code vector index of the at least two code vector indexes, and, if this checking yields a positive result, selecting this further code vector index and proceeding with said transforming and updating.

After updating the single code vector index is performed as mentioned above, it is checked whether there is a further code vector index of the at least two code vector indexes. If this checking yields a positive result, this further code vector index is selected and it is proceeded with transforming the single code vector index to a representation being associated with an enhanced room and with updating the single code vector index as explained above.

Thus, the counter k may be incremented if the checking yields a positive result and the selected code vector index may be denoted as Iₖ.

Accordingly, in this way a loop may be passed through until there is no further code vector index to be combined on the single code vector index. Then it may be stopped.

For instance, the single code vector index may result as:

$$I = {\sum }_{k = 0}^{n - 1} ( {I}_{k} \cdot {\prod }_{l = k + 1}^{n - 1} {N}_{l} ) = {I}_{0} \cdot {N}_{1} \cdot … \cdot {N}_{n - 1} + {I}_{1} \cdot {N}_{2} \cdot … \cdot {N}_{n - 1} + … + {I}_{n - 2} \cdot {N}_{n - 1} + {I}_{n - 1} \qquad ( 9 )$$

This single code vector index obtained by means of equation (9) may equal to the single code vector index obtained by means of equation (4) for exactly the inverse order with respect to the index of the code vector indexes and the sizes. For instance, the order in which the codebooks of the at least two codevectors are taken depends on the codebook sizes, wherein smaller codebooks having a smaller size are chosen first in accordance with the order. For example, a corresponding representation for deriving the index in accordance with the selected order of codebooks is derived. For instance, this representation may be a formular or a look-up table or the like. As an example, this representative may be transmitted or provided. Thus, the complexity of forming the index in accordance with equation (9) may be lower, since less operations with big numbers will be performed.

According to a sixth aspect of the invention, a method is disclosed, comprising extracting at least one code vector index from a single code vector index, wherein the single code vector index single code vector index is based on a combination of at least two code vector indexes, each code vector index being associated with a code vector of a respective codebook.

According to a seventh aspect of the invention, an apparatus is disclosed, which is configured to perform the method according to the first aspect of the invention, or which comprises means for performing the method according to the first aspect of the invention, i.e. means for extracting at least one code vector index from a single code vector index, wherein the single code vector index single code vector index is based on a combination of at least two code vector indexes, each code vector index being associated with a code vector of a respective codebook.

According to an eighth aspect of the invention, an apparatus is disclosed, comprising at least one processor and at least one memory including computer program code, the at least one memory and the computer program code configured to, with the at least one processor, cause the apparatus at least to perform the method according to the first aspect of the invention. The computer program code included in the memory may for instance at least partially represent software and/or firmware for the processor. Non-limiting examples of the memory are a Random-Access Memory (RAM) or a Read-Only Memory (ROM) that is accessible by the processor.

According to a ninth aspect of the invention, a computer program is disclosed, comprising program code for performing the method according to the first aspect of the invention when the computer program is executed on a processor. The computer program may for instance be distributable via a network, such as for instance the Internet. The computer program may for instance be storable or encodable in a computer-readable medium. The computer program may for instance at least partially represent software and/or firmware of the processor.

According to a tenth aspect of the invention, a computer-readable medium is disclosed, having a computer program according to the fourth aspect of the invention stored thereon. The computer-readable medium may for instance be embodied as an electric, magnetic, electro-magnetic, optic or other storage medium, and may either be a removable medium or a medium that is fixedly installed in an apparatus or device. Non-limiting examples of such a computer-readable medium are a RAM or ROM. The computer-readable medium may for instance be a tangible medium, for instance a tangible storage medium. A computer-readable medium is understood to be readable by a computer, such as for instance a processor.

In the following, features and embodiments pertaining to all of these above-described aspects of the invention will be briefly summarized.

For instance, said single code vector index may have been generated by any of the above-mentioned first to fifth aspects of the invention.

This single code vector index may for instance be obtained by reception, or may be internally obtained from a process or program that is executed by the processor. This process of program may for instance be part of an encoding process. The input vector may for instance be representative of at least a part of a speech, audio, image and/or video signal. The input vector may for instance comprise differential spectral data or Line Spectral Frequency (LSF) coefficients of a speech signal, to name but a few examples.

At least one or each of the at least two code vectors associated with the single code vector indexes can be extracted from the single code vector index.

Afterwards, for each of the extracted code vector index the respective code vector in the respective codebook can be obtained. For instance, the code vector index may comprise information about the respective codebook, or, the code vector index may not comprise information about the respective codebook. In the latter case, as an example, a separate information being indicative of the respective codebook associated with each of the at least two code vector indexes may be used to determine the respective codebook. This separate information may also be obtained by reception as mentioned above.

The number of code vector indexes associated with the single code vector index may be determined/obtained, wherein this number may be denoted as n.

According to an exemplary embodiment of aspect fifth to tenth of the invention, said extracting comprises: determining a size value based on the size of one of the at least one codebook which has been used for enhancing a room with respect to the actual single code vector index, determining a code vector index based on determining the remainder of an integer division of the actual single code vector index and the size value, and updating the actual single code vector index by reducing the size of the single code vector index based on the size value.

For instance, said size value of one of the at least one codebook which has been used for enhancing a room with respect to the actual single code vector may represent the size of the codebook of the at least one codebook associated with the actual single code vector index which was not multiplied with the code vector index to be determined but, wherein this size of the codebook was multiplied with the remaining at least one code vector index associated with the actual single code vector.

As an example, under the non-limiting example of a loop index k, wherein k=0 may hold for the first iteration and wherein k is incremented for each further iteration, and with respect to a single code vector index which has been generated based on or equivalent to equation (4), at k=0 the actual single code vector index may represent the code vector index obtained by equation (4). Thus, in order to determine a code vector index from said actual single code vector index, the size of the codebook of the at least one codebook associated with the actual single code vector index which was not multiplied with the code vector index to be determined, wherein this size of the codebook was multiplied with the remaining at least one code vector index associated with the actual single code vector, represents the size Nₖ=N₀ of codebook Cₖ=C₀, because Nₖ=N₀ is multiplied with each of the code vector indexes Iₖ₊₁ . . . Iₙ₋₁ but is not multiplied with code vector index Iₖ, which represents the code vector index to be determined.

Then, the code vector index Iₖ may be determined based on determining the remainder of the integer division of the actual single code vector index and the size value Nₖ=N₀. For instance, the code vector index Iₖ may represent this remainder.

Or, as an example, under the non-limiting example of a loop index k, wherein k=n−1 may hold for the first iteration and wherein k is decremented for each further iteration, and with respect to a single code vector index which has been generated based on or equivalent to equation (9), at k=n−1 the actual single code vector index may represent the code vector index obtained by equation (9). Thus, in order to determine a code vector index from said actual single code vector index, the size of the codebook of the at least one codebook associated with the actual single code vector index which was not multiplied with the code vector index to be determined, wherein this size of the codebook was multiplied with the remaining at least one code vector index associated with the actual single code vector, represents the size Nₖ=Nₙ₋₁ of codebook Cₖ=Cₙ₋₁, because Nₖ=Nₙ₋₁ is multiplied with each of the code vector indexes I₀ . . . Iₙ₋₂ but is not multiplied with code vector index Iₙ₋₁, which represents the code vector index to be determined.

Then, the code vector index Iₖ may be determined based on determining the remainder of the integer division of the actual single code vector index and the size value Nₖ=Nₙ₋₁. For instance, the code vector index Iₖ may represent this remainder.

Afterwards, if a further code vector index is to be determined from the actual single code vector index, the actual single code vector index may be updated based on reducing the size of the actual code vector index based on the determined size value. For instance, the actual single code vector index I may be updated by the integer division of the actual single code vector index I and size value, i.e, the updating may be performed by I=int(I/Nₖ).

According to an exemplary embodiment of aspect fifth to tenth of the invention, after determining a code vector index, it is checked whether there is a further code vector index to be extracted, and, if this checking yields a positive result, it is proceeded with determining a size value based on the size of one of the at least one codebook which has been used for enhancing a room with respect to the actual single code vector index and determining a code vector index based on determining the remainder of an integer division of the actual single code vector index and the size value.

For instance, it this checking yields a positive result the loop counter may be incremented or decremented in accordance with the respective type of loop.

For instance, with respect to the above mentioned single code vector index based on equation (4), k may be incremented. Then, in order to determine a code vector index from said actual single code vector index, the size of the codebook of the at least one codebook associated with the actual single code vector index which was not multiplied with the code vector index to be determined, wherein this size of the codebook was multiplied with the remaining at least one code vector index associated with the actual single code vector, represents the size Nₖ of codebook Cₖ, because Nₖ is multiplied with each of the code vector indexes Iₖ₊₁ . . . Iₙ₋₁ but is not multiplied with code vector index Iₖ, which represents the code vector index to be determined.

Then, the code vector index Iₖ may be determined based on determining the remainder of the integer division of the actual single code vector index and the size value Nₖ. For instance, the code vector index Iₖ may represent this remainder.

For instance, with respect to the above mentioned single code vector index based on equation (9), k may be decremented. Then, in order to determine a code vector index from said actual single code vector index, the size of the codebook of the at least one codebook associated with the actual single code vector index which was not multiplied with the code vector index to be determined, wherein this size of the codebook was multiplied with the remaining at least one code vector index associated with the actual single code vector, represents the size Nₖ of codebook Cₖ, because Nₖ is multiplied with each of the code vector indexes I₀ . . . Iₖ₋₁ but is not multiplied with code vector index Iₖ, which represents the code vector index to be determined.

Afterwards, if a further code vector index is to be determined from the actual single code vector index, the actual single code vector index may be updated based on reducing the size of the actual code vector index based on the determined size value. For instance, the actual single code vector index I may be updated by the integer division of the actual single code vector index I and size value, i.e., the updating may be performed by I=int (i/Nₖ). Then, the loop may proceed with the next iteration.

Furthermore, if there is only one code vector index to be extracted from the actual single code vector index, the loop may not proceed with the next determining of a size value, and the last code vector index represents the value of the updated single code vector index.

For instance, with respect to the above mentioned single code vector index based on equation (4), an example of an extracting procedure may be summarized as follows based on a pseudo C-code:

for k=0:n−2

Iₖ = rem(I,Nₖ)
I = int(I/Nₖ)

end
Iₙ₋₁ = I

Rem represents a function which returns the remainder of the integer division int(I/Nₖ), and k represents an integer which is incremented from 0 to n−2.

For instance, with respect to the above mentioned single code vector index based on equation (9), an example of a decoding procedure may be summarized as follows based on a pseudo code:

for k=n−1:1:−1 (descending order, i.e., k is decremented)

Iₖ = rem(I/ Nₖ)
I = int (I/ Nₖ)

end
I₀ = I

It has to be understood that the loops in these pseudo code examples are not limiting and may be arranged in a different way in order to extract the at least two code vector indexes from the single code vector index.

According to an exemplary embodiment of aspect fifth to tenth of the invention, a size value based on the sizes of the codebooks which have been used for enhancing a room with respect to the actual single code vector index is determined; a size-reduced representation of the actual single code vector index based on the size value is determined; and a code vector index from the size-reduced representation of the actual single code vector index is determined.

Thus, a size value based on the sizes of the codebooks which have been used for enhancing the room of a code vector index representation or for enhancing the room with respect to the actual single code vector index is determined, wherein the sizes of the codebooks may represent the sizes of the codebooks which have been used for enhancing the room of a code vector index representation or for enhancing the room of the single code vector index(es). These sizes may be denoted as relevant codebook sizes.

Thus, for instance, if equation (4) has been used as a basis for determining the single code vector index, the sizes N₀ . . . Nₙ₋₂₋ₖ of respective codebooks C₀ . . . Cₙ₋₂₋ₖ are determined/obtained. For instance, this may be done based on the information about the respective codebooks of a respective code vector contained in the single code vector index. Or, for instance, if equation (9) has been used as a basis for determining the single code vector index, the sizes N₁₊ₖ . . . Nₙ₋₁ of respective codebooks C₁₊ₖ . . . Cₙ₋₁ may be determined/obtained. When this is performed at the first time, k=0 may hold, wherein k may represent a loop counter.

The size value may represent a multiplication of the sizes of the relevant codebook sizes. This value may be denoted as s. Thus, if equation (4) has been used as a basis for determining the single code vector index, s=N₀· . . . ·Nₙ₋₂₋ₖ may hold, or, if equation (9) has been used as a basis for determining the single code vector index, the sizes s=N₁₊ₖ· . . . ·Nₙ₋₁ may hold.

Then, a size-reduced representation of the actual single code vector index I may be obtained by means of transforming the size of the actual single code vector index to the size-reduced representation based on the sizes of the relevant codebook sizes, i.e., based on s. For instance, this size-reduced representation may be a value r which is obtained based on a division of the single code vector index I and value s. As an example, value r may be represented by r=I/s.

Afterwards, one of the code vector indexes associated with the single code vector index I may be obtained based the size-reduced representation of the single code vector index, e.g., based on value r. As an example, this code vector index may be determined based on an integer division of I and s, for instance, by or based on truncating the value r. Truncation may be performed by disregarding the digits right to the decimal point. Any other suited mathematical operation may be used to determine one code vector index based on the single code vector index I and value s.

As an example, under the assumption that equation (4) has been used as a basis for determining the single code vector index, and under assumption of a loop index k=0, code vector index Iₙ₋₁₋ₖ for instance may be determined based on the integer division of I and s, i.e., int(I/s). For instance, this integer division may be performed by Iₙ₋₁₋ₖ=trunc(I/s), or it may be performed based on the result of the integer division int(I/s) providing the integer divisor and the remainder or by any other well suited integer division. Thus, for instance, it is not necessary to provide the real number of the division I/s.

Or, as an example, under the assumption that equation (9) has been used as a basis for determining the single code vector index, and under assumption of a loop index k=0, code vector index Iₖ may be determined based on the integer division of I and s, i.e., int(I/s). For instance, this integer division may be performed by Iₖ=trunc(I/s), or it may be performed based on the result of the integer division int (I/s) providing the integer divisor and the remainder or by any other well suited integer division. Thus, for instance, it is not necessary to provide the real number of the division I/s

This extracted code vector index may be denoted as IE.

According to an exemplary embodiment of aspect sixth to tenth of the invention, after a code vector index is determined, it is proceeded with checking whether there is a further code vector index to be extracted, and, if this checking yields a positive result, determining an updated actual single code vector index based on the actual single code vector index and the previously determined code vector index by means of removing the information associated with the previously determined extracted code vector index from the actual single code vector index and proceeding with said determining a size value, determining a size-reduced representation of the actual single code vector index, if necessary, and with determining a code vector index.

Thus, it is checked whether there is a further code vector index to be extracted. If this checking yields a positive result, an updated actual single code vector index is determined based on the actual single code vector index and the previously extracted code vector index IE by means of removing the information associated with the previously extracted code vector index IE from the single code vector index.

For instance, said removing the information associated with the previously extracted code vector index IE from the single code vector index may be performed by subtracting a value based on the multiplication of the size value (value s) and the previously extracted code vector index IE from single code vector index:

I=I−s·IE (10)

For instance, the loop counter k may be incremented.

Afterwards, the size value is determined, where a new a size value s based on the sizes of the codebooks which have been used for enhancing the room of a code vector index representation or for enhancing the room with respect to the actual single code vector index is determined, as explained above.

Thus, for instance, if equation (4) has been used as a basis for determining the single code vector index, the sizes N₀ . . . Nₙ₋₂₋ₖ of respective codebooks C₀ . . . Cₙ₋₂₋ₖ may be determined/obtained. For instance, this may be done based on the information about the respective codebooks of a respective code vector contained in the single code vector index. Or, for instance, if equation (9) has been used as a basis for determining the single code vector index, the sizes Nₖ₊₁ . . . Nₙ₋₁ of respective codebooks C₁₊ₖ . . . Cₙ₋₁ are determined/obtained.

The size value may be determined in an iterative way based on the previously determined size value, wherein s=s/Nₙ₋₁₋ₖ may hold with respect to a single code vector index based on equation (4) or wherein s=s/Nₖ may hold with respect to a single code vector index based on equation (9).

Then, a size-reduced representation of the updated actual single code vector index is determined, as explained above.

Determining a new size value and determining a size-reduced representation may be cancelled if the actual single code vector index is only associated with a single one code vector index.

Then, one of the code vector indexes associated with the single code vector index I may be obtained based the size-reduced representation of the single code vector index, e.g., based on value r. As an example, this code vector index may be determined based on an integer division of I and s, for instance, by or based on truncating the value r. Truncation may be performed by disregarding the digits right to the decimal point. Any other suited mathematical operation may be used to determine one code vector index based on the single code vector index I and value s. If determining a new size value and determining a size-reduced representation have been cancelled, the size-reduced representation of the single code vector index represents the actual single code vector index.

As an example, under the assumption that equation (4) has been used as a basis for determining the single code vector index, code vector index Iₙ₋₁₋ₖ for instance may be determined based on the integer division of I and s, i.e., int(I/s). For instance, this integer division may be performed by Iₙ₋₁₋ₖ=trunc(I/s), or it may be performed based on the result of the integer division int(I/s) providing the integer divisor and the remainder or by any other well suited integer division. Thus, for instance, it is not necessary to provide the real number of the division I/s.

Or, as an example, under the assumption that equation (9) has been used as a basis for determining the single code vector index, code vector index Iₖ for instance may be determined based on the integer division of I and s, i.e., int(I/s). For instance, this integer division may be performed by Iₖ=trunc(I/s), or it may be performed based on the result of the integer division int(I/s) providing the integer divisor and the remainder or by any other well suited integer division. Thus, for instance, it is not necessary to provide the real number of the division I/s.

Thus, by means of this loop, the at least two code vector indexes may be extracted from the single code vector index.

According to an exemplary embodiment of aspect fifth to tenth of the invention, for at least one of the extracted code vector index the respective code vector in the respective codebook is obtained. For instance, the code vector index may comprise information about the respective codebook, or, the code vector index may not comprise information about the respective codebook. In the latter case, as an example, a separate information being indicative of the respective codebook associated with each of the at least two code vector indexes may be used to determine the respective codebook. This separate information may also be obtained by reception as mentioned above.

For instance, each obtained code vector may be inserted in a corresponding position of a vector of at least two vectors. Thus, the at least one vector used with respect to the first to fifth aspect of the invention may be at least partially reconstructed by means of the obtained code vectors.

As a non-limiting example, each vector may be associated with a separate quantization stage, wherein the single code vector index is associated with at least two quantization stages.

According to a eleventh aspect of the invention, a system is disclosed, comprising a first apparatus according to any of the second and third aspect of the invention and a second apparatus according to any of the seventh and eight aspect of the invention.

According to an exemplary embodiment of all aspects of the invention, the vector and/or the sub vectors at least partially represents at least one of a video, image, audio and speech signal.

According to an exemplary embodiment of all aspects of the invention, the identifying of the target vector forms part of a Third Generation Partnership Project (3GPP) speech and/or audio codec, in particular an Enhanced Voice Service (EVS) codec.

Other features of all aspects of the invention will be apparent from and elucidated with reference to the detailed description of embodiments of the invention presented hereinafter in conjunction with the accompanying drawings. It is to be understood, however, that the drawings are designed solely for purposes of illustration and not as a definition of the limits of the invention, for which reference should be made to the appended claims. It should further be understood that the drawings are not drawn to scale and that they are merely intended to conceptually illustrate the structures and procedures described therein. In particular, presence of features in the drawings should not be considered to render these features mandatory for the invention.

### BRIEF DESCRIPTION OF THE FIGURES

In the figures show:

FIG. 1a: A schematic illustration of an apparatus according to an embodiment of the invention;

FIG. 1b: a tangible storage medium according to an embodiment of the invention;

FIG. 2a: a flowchart of a method according to a first embodiment of the invention;

FIG. 2b: a flowchart of a mathematical operation according to an embodiment of the invention;

FIG. 2c: a flowchart of an extraction operation according to an embodiment of the invention;

FIG. 3a: a flowchart of a method according to a second embodiment of the invention;

FIG. 3b: a flowchart of a method according to a third embodiment of the invention;

FIG. 4a: a flowchart of a method according to a fourth embodiment of the invention;

FIG. 4b: a flowchart of a method according to a fifth embodiment of the invention;

FIG. 5: a flowchart of a method according to a sixth embodiment of the invention;

FIG. 6: a flowchart of a method according to a seventh embodiment of the invention;

FIG. 7a: a flowchart of a method according to a eighth embodiment of the invention; and

FIG. 7b: a flowchart of a method according to a ninth embodiment of the invention.

### DETAILED DESCRIPTION OF EMBODIMENTS OF THE INVENTION

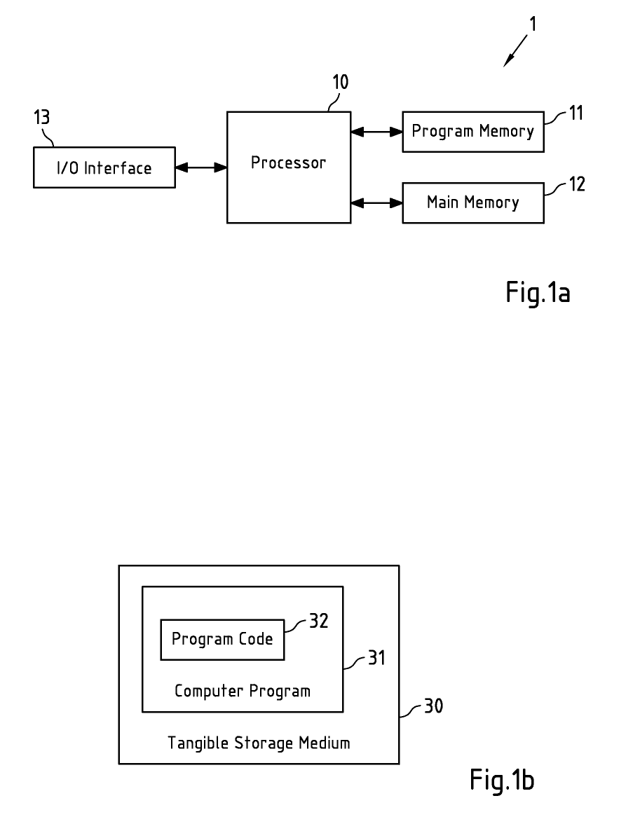

FIG. 1 schematically illustrates components of an apparatus 1 according to an embodiment of the invention. Apparatus 1 may for instance be an electronic device that is for instance capable of encoding at least one of speech, audio and video signals, or a component of such a device. Apparatus 1 is in particular configured to identify one or more target vectors from a plurality of candidate vectors. Apparatus 1 may for instance be embodied as a module. Non-limiting examples of apparatus 1 are a mobile phone, a personal digital assistant, a portable multimedia (audio and/or video) player, and a computer (e.g. a laptop or desktop computer).

Apparatus 1 comprises a processor 10, which may for instance be embodied as a microprocessor, Digital Signal Processor (DSP) or Application Specific Integrated Circuit (ASIC), to name but a few non-limiting examples. Processor 10 executes a program code stored in program memory 11, and uses main memory 12 as a working memory, for instance to at least temporarily store intermediate results, but also to store for instance pre-defined and/or pre-computed databases. Some or all of memories 11 and 12 may also be included into processor 10. Memories 11 and/or 12 may for instance be embodied as Read-Only Memory (ROM), Random Access Memory (RAM), to name but a few non-limiting examples. One of or both of memories 11 and 12 may be fixedly connected to processor 10 or removable from processor 10, for instance in the form of a memory card or stick.

Processor 10 further controls an input/output (I/O) interface 13, via which processor receives or provides information to other functional units.

As will be described below, processor 10 is at least capable to execute program code for identifying one or more target vectors from a plurality of candidate vectors. However, processor 10 may of course possess further capabilities. For instance, processor 10 may be capable of at least one of speech, audio and video encoding, for instance based on sampled input values. Processor 10 may additionally or alternatively be capable of controlling operation of a portable communication and/or multimedia device.

Apparatus 1 of FIG. 1 may further comprise components such as a user interface, for instance to allow a user of apparatus 1 to interact with processor 10, or an antenna with associated radio frequency (RF) circuitry to enable apparatus 1 to perform wireless communication.

The circuitry formed by the components of apparatus 1 may be implemented in hardware alone, partially in hardware and in software, or in software only, as further described at the end of this specification.

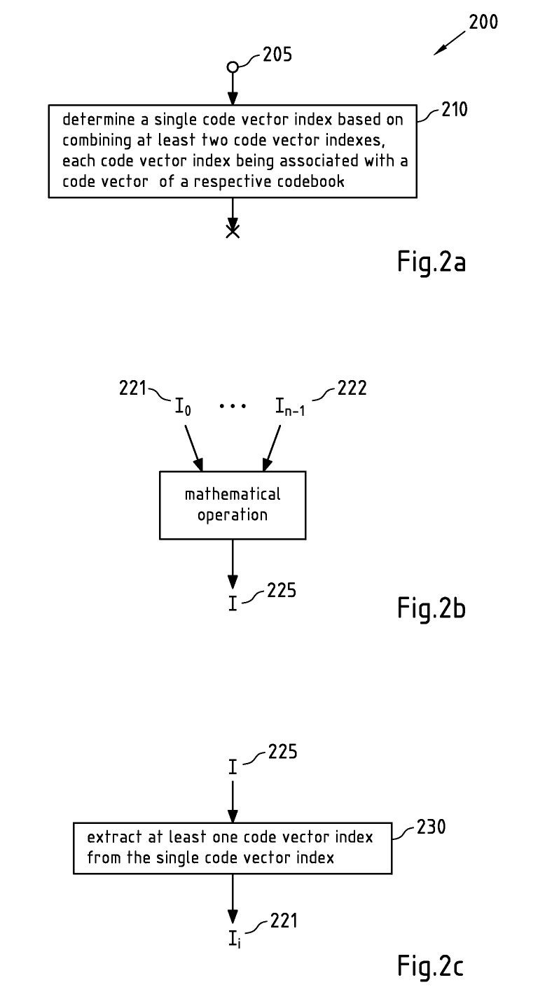

FIG. 2a shows a flowchart 200 of a method according to an embodiment of the invention. The steps of this flowchart 200 may for instance be defined by respective program code 32 of a computer program 31 that is stored on a tangible storage medium 30, as shown in FIG. 1b. Tangible storage medium 30 may for instance embody program memory 11 of FIG. 1, and the computer program 31 may then be executed by processor 10 of FIG. 1.

Returning to FIG. 2a, in a step 210 a single code vector index is determined based on combining at least two code vector indexes, each code vector being associated with a code vector of a respective codebook.

For instance, there may exist at least one codebook, wherein each of the at least one codebook is associated with a code vector leader class comprising at least one code vector, wherein a code vector index of the at least two code vector indexes is associated with a code vector of the respective codebook, and wherein said respective codebook is one of the at least one codebook. Accordingly, a code vector index of the at least two code vector indexes is associated with a respective codebook.

Accordingly, at least two code vector indexes may be provided, wherein each of the at least two code vector indexes represents a code vector of a respective codebook. As an example, the at least two code vector indexes may be associated with different codebooks, i.e., the at least one codebook represents at least two codebooks, wherein a first code vector index of the at least two code vector indexes is associated with a first codebook of the at least two codebooks, and wherein a second code index of the at least two code vector indexes is associated with a second codebook of the at least two codebooks, the second codebook being different from the first codebook. Or, for instance, a first code vector index of the at least two code vector indexes is associated with a same codebook as a second code vector index of the at least two code vector indexes, wherein, as an example, the first code vector index may be associated with a code vector of this codebook and the second code vector index of this codebook may be associated with another or the same code vector of this codebook.

The single code vector index may be considered as a representative of the at least two code vector indexes. The combining may represent any suited mathematical operation in order to determine the single code vector index. Thus, the single code vector index comprises information on each of the at least two code vector indexes. The information on each of the at least two code vector indexes may be extracted from the single code vector index. Accordingly, at least one or each of the at least two code vectors associated with the single code vector indexes can be extracted from the single code vector index. Afterwards, for each of the extracted code vector index the respective code vector in the respective codebook can be obtained. For instance, the code vector index may comprise information about the respective codebook, or, the code vector index may not comprise information about the respective codebook. In the latter case, as an example, a separate information being indicative of the respective codebook associated with each of the at least two code vector indexes may be obtained and may be provided at an encoder.

For instance, the single code vector index I may represent a value 225 and each of the at least two code vector indexes T₀ . . . Iₙ₋₁ 221, 222 may represent a value, as depicted in FIG. 2b, wherein n denotes the number of code vector indexes. The values of the least two code vector indexes may be combined by means of an invertible mathematical operation 220, wherein invertible has to be understood in a manner that at least one code vector index Iₖ (wherein k in 0 . . . n−1 holds) of the at least two code vector indexes can be extracted from the single code vector index 225, as depicted in step 230 in FIG. 2c.

The single code vector index may be in a binary representation.

As an example, the single code vector index may be associated with a combined code vector of a combined codebook. This combined code vector may comprise information on the at least two code vectors. Furthermore, the combined codebook may be based on a combination of the codebooks associated with the at least two code vector indexes.

For instance, the combined codebook may comprise a plurality of combined code vectors, wherein each of the combined code vectors may be a representation of a combination of one code vector cₖ of each respective codebook Cₖ (wherein k in 0 . . . n−1 holds) being associated with a respective code vector index of the at least two code vector indexes I₀ . . . Iₙ₋₁. As an example, a combined code vector may be a representation of a combination of c₀, c₁, . . . , cₖ₋₁, wherein cₖ (wherein k in 0 . . . n−1 holds) is a code vector of the respective kth codebook Cₖ.

For instance, in case the ith code vector index of the at least two code vector indexes is associated with a respective codebook Cᵢ comprising Nᵢ code vectors, the combined codebook may comprise N₀· . . . ·Nₙ₋₁ code vectors due to the possible number of permutations.

The usage of this combined codebook may lead to a lower number of bits when quantizing the at least two code vector indexes. If each of the at least two code vector indexes would be quantized in the respective codebook the number of bits to encode the n (where n is an integer and n>1 holds) code vectors is

$${\sum }_{k = 0}^{n - 1} ceil ( {log}_{2} ( {N}_{k} ) ) , \qquad ( 11 )$$

where the ceil function gives the closest higher integer.

If the n code vectors are coded together by considering the combined codebook of N₀· . . . ·Nₙ code vectors the number of bits is

$$ceil ( {\sum }_{k = 0}^{n - 1} {log}_{2} ( {N}_{k} ) ) , \qquad ( 12 )$$

which may give a lower number of bits for the same quantization distortion, i.e.,

$$ceil ( {\sum }_{k = 0}^{n - 1} {log}_{2} ( {N}_{k} ) ) \leq {\sum }_{k = 0}^{n - 1} ceil ( {log}_{2} ( {N}_{k} ) ) \qquad ( 13 )$$

holds.

The single code vector index may be provided, for instance to another component via I/O output 13 of FIG. 1, or internally to another process of program executed by processor 10. Alternatively or additionally, further processing based on the one or more target vectors may be performed (by processor 10).

For instance, the single code vector index may be denoted as I, and the at least two code vector indexes may represent n code vector indexes, i.e., integer n>1 holds, wherein a code vector index of said n code vector indexes may be denoted as Iₖ, wherein k in 0 . . . n−1 holds. Each code vector index Iₖ is associated with a code vector of a respective codebook Cₖ, wherein this codebook Cₖ comprises Nₖ code vectors.

As a non-limiting example, the single code vector index may be obtained by the following equation which performs an example of the combining of at least two code vector indexes, Iₖ, wherein kin 0 . . . n−1 holds, each of the code vector indexes Iₖ being associated with a code vector of a respective code book Cₖ:

$$I = {\sum }_{k = 0}^{n - 1} ( {I}_{k} \cdot {\prod }_{l = 0}^{k - 1} {N}_{l} ) = {I}_{0} + {N}_{0} \cdot {I}_{1} + … + {N}_{0} \cdot … \cdot {N}_{n - 2} \cdot {I}_{n - 1} \qquad ( 14 )$$

For instance, as a non-limiting example, a code vector index Iₖ may be represented by an integer value in range from 0 to Nₖ−1.

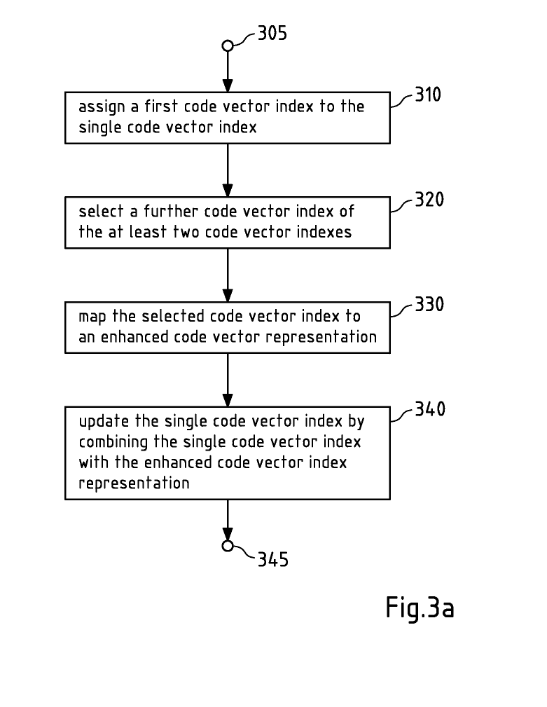

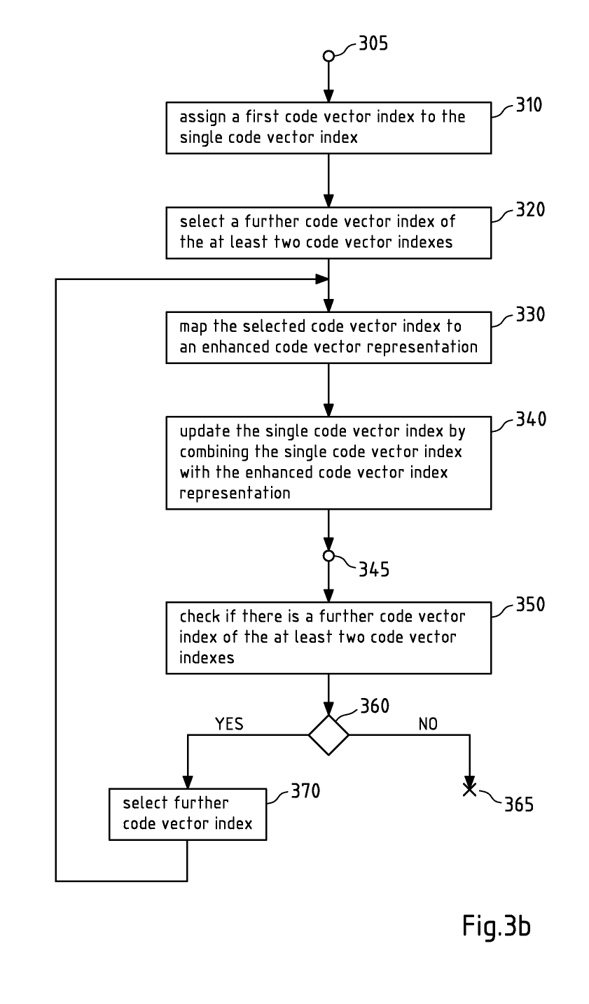

FIG. 3a depicts a flowchart of a method according to a second embodiment of the invention.

In step 310 a first code vector index of the at least two code vector indexes is assigned to the single code vector index. Thus, the actual single code vector index may represent the first code vector index. This first code vector index may be denoted as Iₖ, wherein k may represent a counter of a loop and wherein k=0 may hold when starting the loop. Furthermore, the single code vector index may be denoted as I, i.e., I=I₀ may hold during loop k=0.

The first code vector index Iₖ is associated with a code vector of a respective codebook Cₖ, wherein k=0 holds. Accordingly, the actual single code vector index is associated with this codebook Cₖ, wherein k=0 holds.

Then a further code vector index of the at least two code vector indexes is selected, as indicated by step 320 in FIG. 3a. For instance, this further code vector index may be denoted as Iₖ, wherein k may be incremented, i.e., k=1 may hold for this selection.

Afterwards, the selected code vector index Iₖ is mapped to an enhanced code vector representation, as indicated by step 330 in FIG. 3a. This enhanced code vector index representation takes into account the at least one codebook being associated with the actual single code vector index. Considering loop k, this at least one codebook being associated with the actual single code vector index represents the codebooks C₀, . . . , Cₖ₋₁.

For instance, the enhanced code vector index representation may be associated with an enhanced room of a size depending on the size of the codebook of the selected code vector index and on the size of each of the at least one codebook being associated with the actual single code vector index. Thus, mapping the selected code vector index Iₖ to an enhanced code vector index representation may comprise transforming the selected code vector index Iₖ to this room.

For instance, if code vector index Iₖ is associated with a code vector of a respective codebook Cₖ, wherein this codebook Cₖ comprises Nₖ code vectors, the code vector index Iₖ may be considered to be associated with a room of size Nₖ, since there exist Nₖ different code vector indexes associated with codebook Cₖ. In other words, a representation of size Nₖ may be necessary for representing the code vector index Iₖ.

The size of each of the at least one codebook being associated with the actual single code vector index depends on the size Nₗ of codebook Cₗ for each l, wherein l in 0 . . . k−1 holds, respectively.

Accordingly, the enhanced room associated with the enhanced code vector index representation may provide sufficient room for each permutation of the code vectors c₀, . . . , cₗ, wherein cₗ (wherein l in 0 . . . k holds) is a code vector of the respective kth codebook Cₗ.

For instance, the enhanced code vector index representation may be denoted as Eₖ, wherein Eₖ=f (Iₖ, N₀ . . . Nₖ₋₁) may hold.

As an non-limiting example, said mapping the selected code vector index Iₖ to an enhanced code vector index representation Eₖ may be based on a multiplication of the selected code vector index Iₖ and a value depending on the size of each of the at least one codebook being associated with actual single code vector index, i.e., depending on the sizes N₀ . . . Nₖ₋₁. This value, which may denoted as V, under the assumption that k>2 holds, may represent a value being indicative of the size of the combined codebooks N₀ . . . Nₖ₋₁ being associated with the actual single code vector index, or, if k=1 holds, the value may be indicative of the size of the codebook N₀.

For instance, the enhanced code vector index representation Eₖ may represent a value in a number range which is greater than the number range of possible values of the actual single code vector index I. Said number range of possible values of the actual single code vector index I may be defined by the possible permutations of code vectors c₀, . . . , cₗ, of the code vector indexes associated with the actual single code vector index I, wherein l in 0 . . . k−1 holds.

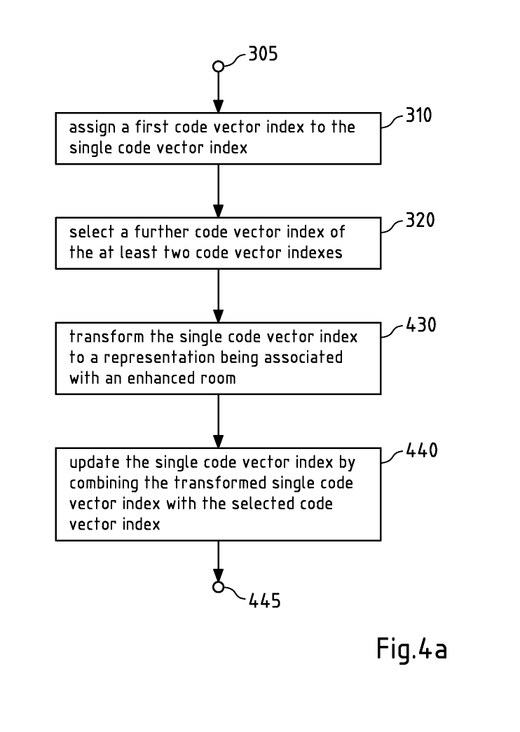

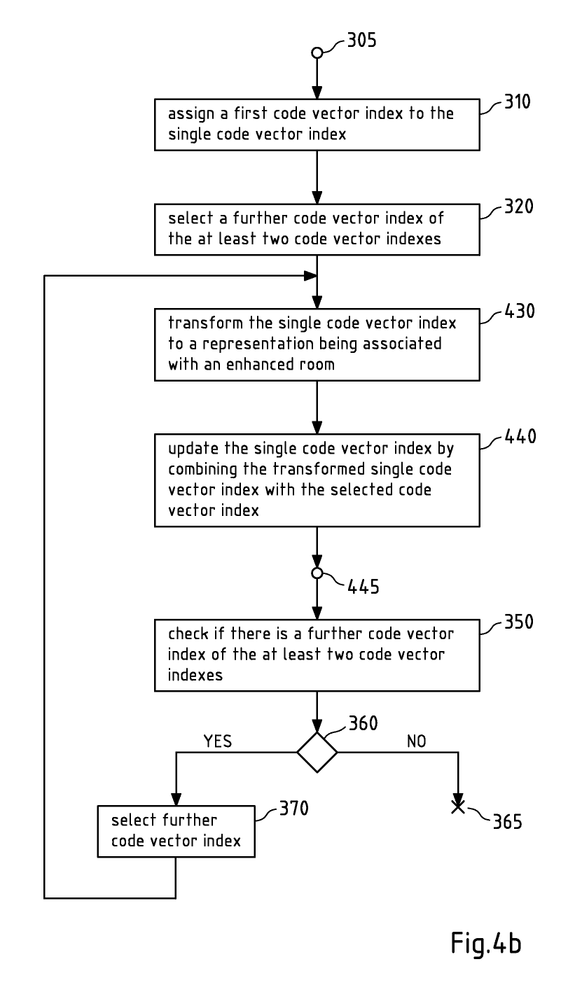

For instance, with regard to example equation (14) presented with respect to the first method 200 depicted in FIG. 4, the enhanced code vector index representation may be considered to be represented by

$${E}_{k} = {I}_{k} \cdot \underbrace{{\prod }_{l = 0}^{k - 1} {N}_{l}}_{V} k ∈ \{ 1 , … , n - 1 \} . \qquad ( 15 )$$

In this example, the value V depending on the size of each of the at least one codebook being associated with the single code vector index represents the multiplication of the size of the codebooks N₀ . . . Nₖ₋₁.

After the selected code vector index representation Iₖ is mapped to the enhanced code vector index representation Eₖ, the single code vector representation is updated by combining the single code vector index with the enhanced code vector index representation, as indicated by step 340 in FIG. 3a. Accordingly, after this combining, the single code vector representation I comprises information on each code vector index Iₗ, wherein l in 0 . . . k holds. Thus, I=f(I, Eₖ) may hold, wherein function f represents a function for updating the single code vector based on the enhanced code vector index representation Eₖ. Said combining may represent any well suited mathematical operation.

As a non-limiting example, this combining may be performed by an addition of the actual single code vector representation and the enhanced code vector index Eₖ:

I=I+Eₖ (16)

FIG. 3b depicts a flowchart of a method according to a third embodiment of the invention, which is based on the second embodiment of the invention depicted in FIG. 3a, as indicated by reference sign 345.

After updating the single code vector index is performed in step 340, it is checked whether there is a further code vector index of the at least two code vector indexes, as denoted in step 350 in FIG. 3b. If this checking yields a positive result (step 360), this further code vector index is selected in step 370 and the method proceeds with mapping the selected code vector index to an enhanced vector representation in step 330 and updating the single code vector index in step 340.

Thus, the counter k may be incremented if the checking yields a positive result and the selected code vector index may be denoted as Iₖ.

Accordingly, the loop depicted in FIG. 3b may be passed through until there is no further code vector index to be combined on the single code vector index. Then the method may stop, as indicated by reference sign 365.

FIG. 4a depicts a flowchart of a method according to a fourth embodiment of the invention.

Steps 310 and 320 of the method according to the fourth embodiment correspond to the respective steps depicted in FIGS. 3a and 3b. Thus, the explanations mentioned above with respect to these steps 310 and 320 also hold for this method according to the fourth embodiment depicted in FIG. 4a.

After the further code vector index Iₖ is selected in step 320, the method according to the fourth embodiment proceeds with transforming the single code vector index I to a representation being associated with an enhanced room, as depicted in step 430 in FIG. 4a, the size of this enhanced depending on the size of the codebook of the selected code vector index Iₖ and on the size of each of the at least one codebook being associated with the actual single code vector index I.

Accordingly, the enhanced room associated with the transformed representation of the single code vector index may provide sufficient room for each permutation of the code vectors c₀, . . . , cₗ, wherein cₗ (wherein l in 0 . . . k holds) is a code vector of the respective lth codebook Cₖ.

When the method reaches step 430 at a first time, i.e., when k=1 may hold, the single code vector index I is only associated with the first code vector index I₀, wherein the first code vector index is associated with the codebook C₀. Thus, the single code vector index I is associated with a room corresponding to the size of codebook C₀, i.e., size N₀. Then, the single code vector index I is transformed to a representation being associated with an enhanced room of a size depending on the size Nₖ of the codebook of the selected code vector index and on the size N₀ of the at least one codebook being associated with the actual single code vector index.

As a non-limiting example, this transformation may be performed by means of multiplying the single code vector index I with a value depending on the size Nₖ of the codebook being associated with the selected code vector index Iₖ, i.e.,

I=I·Nₖ (17)

may hold.

Afterwards, the single code vector index I, which is in the representation being associated with the enhanced room, is updated by combining the transformed single code vector index I with the selected code vector index Iₖ in step 440.

Accordingly, after this combining, the single code vector representation I comprises information on each code vector index Iₗ, wherein l in 0 . . . k holds. Thus, I=f(I, Iₖ) may hold, wherein function f represents a function for updating the single code vector based on the transformed single code vector index I and the selected code vector index Iₖ. Said combining may represent any well suited mathematical operation.

As a non-limiting example, this combining may be performed by an addition of the transformed single code vector representation and the selected code vector index Iₖ:

I=I+Iₖ (18)

FIG. 4b depicts a flowchart of a method according to a fifth embodiment of the invention, which is based on the third and the fourth embodiment of the invention depicted in FIGS. 3a and 4b, as indicated by reference sign 445. This method according to a fifth embodiment may be considered to combine the loop of the method according to a third embodiment with the method according to the fourth embodiment for transforming the single code vector index to a representation being associated with an enhanced room and updating the single code vector index by combining the transformed single code vector index with the selected code vector index depicted in FIG. 4a.

After updating the single code vector index is performed in step 440, it is checked whether there is a further code vector index of the at least two code vector indexes, as denoted in step 350 in FIG. 4b. If this checking yields a positive result (step 360), this further code vector index is selected in step 370 and the method proceeds with transforming the single code vector index to a representation being associated with an enhanced room the size of this enhanced depending on the size of the codebook of the selected code vector index Iₖ and on the size of each of the at least one codebook being associated with the actual single code vector index I.

Thus, in step 430, the single code vector index I is associated with a room corresponding to the size of each of codebooks C₀ . . . Cₖ₋₁, i.e., depending on each size N₀ . . . Nₖ₋₁. Then, the single code vector index I is transformed to a representation being associated with an enhanced room of a size depending on the size Nₖ of the codebook of the selected code vector index and on each size N₀ . . . Nₖ₋₁ of the at least one codebook being associated with the actual single code vector index. For instance, this transformation may be performed by means of equation (17).

Then the method proceeds with updating the single code vector index in step 440 as explained above.

Accordingly, the loop depicted in FIG. 4b may be passed through until there is no further code vector index to be combined on the single code vector index. Then the method may stop, as indicated by reference sign 365.

Thus, after the method depicted in FIG. 4b is performed, the single code vector index may be represented as follows:

$$I = {\sum }_{k = 0}^{n - 1} ( {I}_{k} \cdot {\prod }_{l = k + 1}^{n - 1} {N}_{l} ) = {I}_{0} \cdot {N}_{1} \cdot … \cdot {N}_{n - 1} + {I}_{1} \cdot {N}_{2} \cdot … \cdot {N}_{n - 1} + … + {I}_{n - 2} \cdot {N}_{n - 1} + {I}_{n - 1} \qquad ( 19 )$$

FIG. 4b depicts a flowchart of a method according to a fifth embodiment of the invention.

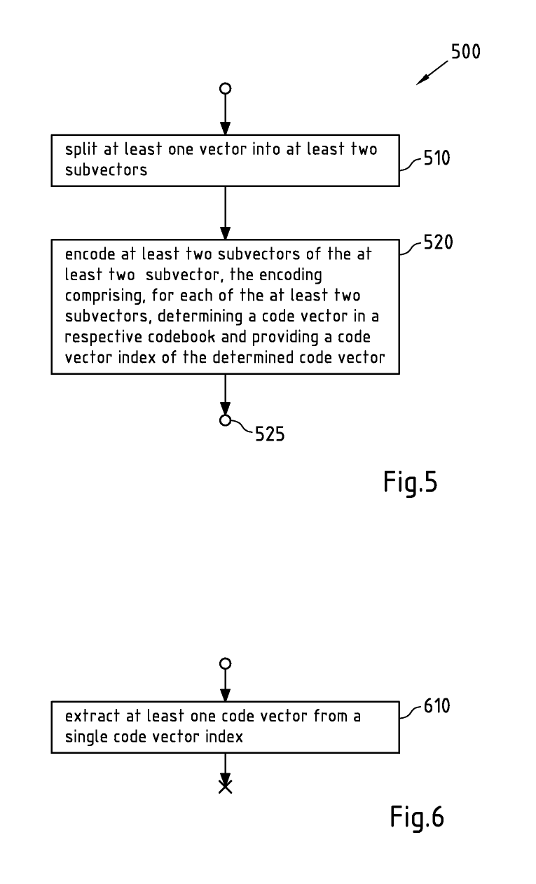

FIG. 5 depicts a flowchart of a method 500 according to a sixth embodiment of the invention.

Method 500 comprises splitting at least one vector into at least two subvectors in step 510. Each vector of the at least one vector may comprise a plurality of coefficients. Each of the at least one subvector comprises at least one coefficient.

This at least one vector may represent any at least one vector comprising data to be encoded. This at least one vector may for instance be obtained by reception (for instance via I/O interface 13 of FIG. 1), or may be internally obtained from a process or program that is executed by processor 10. This process of program may for instance be part of an encoding process. The at least one vector may for instance be representative of at least a part of a speech, audio, image and/or video signal. The at least one vector may for instance comprise differential spectral data or Line Spectral Frequency (LSF) coefficients of a speech signal, to name but a few examples.

For instance, as a non-limiting example, this at least one vector may represent at least one vector obtained during an Adaptive Multi-Rate (AMR)—Wideband (WB) encoding, wherein a Modified Discrete Cosine Transformation (MDTC) is performed on a difference signal and the transform coefficients are encoded. For instance, encoding of these transform coefficients for a bitstream may include encoding a vector comprising a plurality of coefficients with a predetermined amount of bits per bitstream. For instance, a vector may comprise 280 coefficients, wherein this vector is encoded with 160 bits per bitstream. As an example, this vector comprising 280 coefficients may be split into 10 dimensional subvectors resulting in 28 subvectors. Any other well-suited splitting of the vector into the at least two subvectors may also performed.

Then, an encoding is performed for at least two subvectors of the at least two subvectors in step 520. The encoding may be performed by means of at least one codebook, wherein each of the at least one codebook comprises at least one code vectors. Each of the at least two subvectors of the at least two subvectors is encoded with a codevector from one of the at least one codebook. For instance, the nearest codevector from at least one codevector of a codebook of the at least one codebook may be selected for encoding a respective subvector, or the nearest codevector from a plurality of code vectors may be selected for encoding a respective subvector, wherein the plurality of code vectors may represent at least two subvectors from at least two codebooks.

Thus, for each of the at least two subvectors of the at least two subvectors a code vector is determined in a respective codebook of the at least one codebook, as indicated in step 520 in FIG. 5a, and a code vector index of the determined code vector is provided. In case the at least one codebook represents a plurality of codebooks, an indicator of the selected codebook may be provided.

Accordingly, the encoding 520 results in at least two code vector indexes, wherein each of the at least two code vector indexes is associated with a respective codevector in a respective codebook of the at least one codebook. These at least two code vector indexes may be provided to any of the methods according to a first to fifth embodiment of the invention explained above. For instance, the method 500 depicted in FIG. 5, as indicated by reference sign 525, may proceed at a position indicated by reference signs 205 or 305 in FIG. 2a, 3a, 3b, 4a or 4b.

Furthermore, for instance, as non-limiting example with respect to method 500, it is possible to define a lattice codebook as a union of leader classes, each of which is characterized by a leader vector.

Codebooks used within these speech and audio codecs may for instance be based on lattice structures, as described in reference “Multiple-scale leader-lattice VQ with application to LSF quantization” by A. Vasilache, B. Dumitrescu and I. Tabus, Signal Processing, 2002, vol. 82, pages 563-586, Elsevier, which is incorporated herein in its entirety by reference.

A leader vector is an n-dimensional vector (with n denoting an integer number), whose (positive) components are ordered (e.g. decreasingly). The leader class corresponding to the leader vector then consists of the leader vector and all vectors obtained through all the signed permutations of the leader vector (with some possible restrictions). It is also possible that one, some or all leader classes are respectively associated with one or more scales, and the lattice codebook is then formed as a union of scaled and/or unscaled leader classes. For instance, a D10+ lattice may be considered for quantization, but any other well-suited lattice quantization may also be considered.

A subvector may for instance be encoded/quantized by finding the nearest neighbor code vector in the codebook, i.e. the code vector that has the smallest distance with respect to the subvector. An identifier of this code vector (e.g. a codevector index assigned to this code vector) then may serve as a quantized representation of the subvector.

For instance, finding the nearest neighbor code vector in the codebook may comprise for each of the at least two subvectors identifying a leader vector of the plurality of leader vectors, the identified leader vector representing the nearest leader vector with respect to the respective subvector, and identifying the nearest code vector of the plurality of code vectors in the leader vector class associated with the identified leader vector. The identified leader vector for a respective subvector may be represented by a leader vector representation. This leader vector representation may for instance represent a leader vector index. Furthermore, the leader class of this identified leader vector may be considered to represent the respective codebook of the at least one codebook.

The codevector index within the leader vector class may for instance be obtained through an enumeration algorithm as described in reference WO 2009/100768 A1, which is incorporated herein by reference. The leader vector index may be encoded separately from the code vector indexes.

For instance, after a codevector has been determined for each of the at least two subvectors, it may be determined for each of the codevectors whether this codevector represents a null codevector or a non-null codevector. If a codevector represents a non-null codevector, the respective code vector index may be provided as one of the at least two code vector indexes used in any of the methods according to a first to fifth embodiment of the invention explained above. On the other hand, if a codevector represents a null codevector, the respective core vector index may not be provided as one of the at least two code vector indexes. Thus, the at least two code vector indexes used in any the methods according to a first to fifth embodiment of the invention may represent significant code vectors, whereas null codevectors are neglected.

For instance said at least one vector may be associated with at least two stages of quantization.

Thus, the at least two codebooks associated with the single code vector index may be used in a multi-stage quantization comprising at least two stages of quantization. For instance, at each stage of the at least two stages the code vector indexes of the respective subvectors associated with the respective stage may be obtained, and the code vector indexes associated with the at least two stages may be combined to the single code vector index. Thus, there is no constraint that each stage should have a power of two code vectors.

As a non-limiting example, the at least one vector may represent at least two vectors, and each vector of the at least two vectors may be associated with a separate equalization stage.

In the sequel, a method according to a seventh embodiment of the invention will be presented. This method according to a seventh embodiment of the invention may be based on one or more of the methods according to a first, second, third, fourth, and sixth method of the invention and will be explained by means of an C-source example of an implementation.

int
compose_index(int no_vec, /* (i) number of subvectors (n) */

| | |
|---|---|
| int * index, | /* (i) lattice codevector index |

within each leader class, Ii*/

| | |
|---|---|
| int * max_index, | /* (i) number of codevectors for |

each leader class, Ni */

uint32 * composed_idx) /* (o) resulting index

represented on an array of 32bit integers */

{

Int k, len_ci, len_tmp, len_b;
uint32 base[4], tmp[4];
int j;
/* initializations */
for(k=0; k<4; k++)
{

```
  composed_idx[k] = 0;
  base[k] = 0;
  tmp[k] = 0;
```

}
composed_idx[0] = index[0];
len_ci = 1;
base[0] = max_index[0];
len_b = 1;
for(k=1; k<no_vec−1;k++)
{

/* multiplication between a 128 bits integer, represented on
len_n 32bit integers, and a 32bit integer; the result as
a 128 bit integer is output in tmp */

```
  len_tmp = multiply_128_32(base, len_b, index[k], tmp);
  /* addition on 128 bits */
  len_ci = add128(composed_idx, len_ci, tmp, len_tmp,
  composed_idx);
  len_b = multiply_128_32(base, len_b, max_index[k], base);
```

}
/* the operations for the term with In−1 may be done out of the

loop because there is no need to update the base (last multiplication
from the loop)*/

len_tmp = multiply_128_32(base, len_b, index[k], tmp);
len_ci = add128(composed_idx, len_ci, tmp,len_tmp,

composed_idx);

return len_ci;

}

Function compose_index may be considered to perform the method according to a fourth embodiment of the invention depicted in FIG. 3b. Variable composed_idx represents the single code vector index I. After the initialization has been performed, a first code vector index (index[0]) of the at least two code vector indexes is assigned to the single code vector index composed_idx, in accordance with step 310 depicted in FIGS. 3a and 3b.

The at least two code vector indexes represent n code vector indexes, wherein n represents the number of subvectors and is stored in variable no_vec. Accordingly, the remaining n−1 code vectors are combined to the single code vector index performed by loop “for (k=1; k<no_vec−1; k++)” by means of updating the single code vector index in accordance with step 340 depicted in FIGS. 3a and 3b.

When the loop is passed through the first time, i.e., when k=1 holds, the further code vector index Iₖ (index[k]) is selected, in accordance with step 320 depicted in FIGS. 3a and 3b, and this selected further code vector index Iₖ is mapped to an enhanced code vector index representation by means of function multiply_{—}128_{—}32(base, len_b, index[k], tmp), in accordance with step 330 depicted in FIGS. 3a and 3b, wherein the enhanced code vector index representation is stored in variable tmp and wherein variable base represents the above-mentioned value V depending on the size of each of the at least one codebook being associated with the actual single code vector index. When the loop is started the first time, i.e., when k=1 holds, base is equal to the number of codevectors of the leader class associated with first code vector index I₀ (index[0]), i.e., base is equal to the size of the codebook associated with the first code vector index I₀. At the end of the loop, base is updated by means of multiplying the value of base with the number of codevectors of the leader class associated with the kth code vector index Iₖ (index[k]). Accordingly, the enhanced vector representation tmp in loop k may be calculated as

$$tmp = {I}_{k} \cdot \underbrace{{\prod }_{l = 0}^{k - 1} {N}_{l}}_{V} k ∈ \{ 1 , … , n - 1 \} . \qquad ( 20 )$$

in accordance with equation (15).

Updating the single code vector index I (variable composed_idx) is performed by means of adding the actual single code vector index I and the enhance code vector representation tmp, which his performed by add128(composed_idx, len_ci, tmp, len_tmp, composed_idx).

In this example, the last determining of the enhanced code vector index representation and the last updating of the single code vector index composed_idx is performed out of the loop, wherein last means considering the last code vector index Iₙ₋₁, since in this example the value V depending on the size of each of the at least one codebook being associated with the actual single code vector index, which is stored in variable tmp, is calculated at the end of the loop with respect to the sizes N₀ . . . Nₖ of codebooks C₀ . . . Cₖ.

It has to be understood that the chosen 4 32-bit integer representation for the single code vector index composed_idx represents a non-limiting example. The size of the representation of the single code vector index and other variables may differ from this implementation, e.g., depending on the size of the codebooks and/or the number of code vector indexes to be combined to the single code vector index.

FIG. 6 depicts a flowchart of a method 600 according to a seventh embodiment of the invention.

This method 600 comprises extracting at least one code vector index from a single code vector index, wherein the single code vector index single code vector index is based on a combination of at least two code vector indexes, each code vector index being associated with a code vector of a respective codebook, as indicated by step 610 depicted in FIG. 6.

For instance, said single code vector index may have been generated by any of the above-mentioned methods according to the first to sixth embodiment of the invention.

This single code vector index may for instance be obtained by reception (for instance via I/O interface 13 of FIG. 1), or may be internally obtained from a process or program that is executed by processor 10. This process of program may for instance be part of an encoding process. The input vector may for instance be representative of at least apart of a speech, audio, image and/or video signal. The input vector may for instance comprise differential spectral data or Line Spectral Frequency (LSF) coefficients of a speech signal, to name but a few examples.

At least one or each of the at least two code vectors associated with the single code vector indexes can be extracted from the single code vector index.

For instance, this extraction may be performed in accordance with the extraction described with respect to FIG. 2b.

Afterwards, for each of the extracted code vector index the respective code vector in the respective codebook can be obtained. For instance, the code vector index may comprise information about the respective codebook, or, the code vector index may not comprise information about the respective codebook. In the latter case, as an example, a separate information being indicative of the respective codebook associated with each of the at least two code vector indexes may be used to determine the respective codebook. This separate information may also be obtained by reception as mentioned above.

The number of code vector indexes associated with the single code vector index may be determined/obtained, wherein this number may be denoted as n.

For instance, in accordance with a first exemplary embodiment of method 600 according to a seventh embodiment of the invention, said extracting 610 comprises determining a size value based on the size of one of the at least one codebook which has been used for enhancing a room with respect to the actual single code vector index, determining a code vector index based on determining the remainder of an integer division of the actual single code vector index and the size value, and updating the actual single code vector index by reducing the size of the single code vector index based on the size value.

For instance, said size value of one of the at least one codebook which has been used for enhancing a room with respect to the actual single code vector may represent the size of the codebook of the at least one codebook associated with the actual single code vector index which was not multiplied with the code vector index to be determined but, wherein this size of the codebook was multiplied with the remaining at least one code vector index associated with the actual single code vector.

As an example, under the non-limiting example of a loop index k, wherein k=0 may hold for the first iteration and wherein k is incremented for each further iteration, and with respect to a single code vector index which has been generated based on or equivalent to equation (14), at k=0 the actual single code vector index may represent the code vector index obtained by equation (14). Thus, in order to determine a code vector index from said actual single code vector index, the size of the codebook of the at least one codebook associated with the actual single code vector index which was not multiplied with the code vector index to be determined, wherein this size of the codebook was multiplied with the remaining at least one code vector index associated with the actual single code vector, represents the size Nₖ=N₀ of codebook Cₖ=C₀, because Nₖ=N₀ is multiplied with each of the code vector indexes Iₖ₊₁ . . . Iₙ₋₁ but is not multiplied with code vector index Iₖ, which represents the code vector index to be determined.

Then, the code vector index Iₖ may be determined based on determining the remainder of the integer division of the actual single code vector index and the size value Nₖ=N₀. For instance, the code vector index Iₖ may represent this remainder.

Or, as an example, under the non-limiting example of a loop index k, wherein k=n−1 may hold for the first iteration and wherein k is decremented for each further iteration, and with respect to a single code vector index which has been generated based on or equivalent to equation (19), at k=n−1 the actual single code vector index may represent the code vector index obtained by equation (19). Thus, in order to determine a code vector index from said actual single code vector index, the size of the codebook of the at least one codebook associated with the actual single code vector index which was not multiplied with the code vector index to be determined, wherein this size of the codebook was multiplied with the remaining at least one code vector index associated with the actual single code vector, represents the size Nₖ=Nₙ₋₁ of codebook Cₖ=Cₙ₋₁, because Nₖ=Nₙ₋₁ is multiplied with each of the code vector indexes I₀ . . . Iₙ₋₂ but is not multiplied with code vector index Iₙ₋₁, which represents the code vector index to be determined.

Then, the code vector index Iₖ may be determined based on determining the remainder of the integer division of the actual single code vector index and the size value Nₖ=Nₙ₋₁. For instance, the code vector index Iₖ may represent this remainder.

Afterwards, if a further code vector index is to be determined from the actual single code vector index, the actual single code vector index may be updated based on reducing the size of the actual code vector index based on the determined size value. For instance, the actual single code vector index I may be updated by the integer division of the actual single code vector index I and size value, i.e, the updating may be performed by I=int(i/Nₖ).

According to an exemplary embodiment of aspect fifth to tenth of the invention, after determining a code vector index, it is checked whether there is a further code vector index to be extracted, and, if this checking yields a positive result, it is proceeded with determining a size value based on the size of one of the at least one codebook which has been used for enhancing a room with respect to the actual single code vector index and determining a code vector index based on determining the remainder of an integer division of the actual single code vector index and the size value.

For instance, it this checking yields a positive result the loop counter may be incremented or decremented in accordance with the respective type of loop.

For instance, with respect to the above mentioned single code vector index based on equation (14), k may be incremented. Then, in order to determine a code vector index from said actual single code vector index, the size of the codebook of the at least one codebook associated with the actual single code vector index which was not multiplied with the code vector index to be determined, wherein this size of the codebook was multiplied with the remaining at least one code vector index associated with the actual single code vector, represents the size Nₖ of codebook Cₖ, because Nₖ is multiplied with each of the code vector indexes Iₖ₊₁ . . . Iₙ₋₁ but is not multiplied with code vector index Iₖ, which represents the code vector index to be determined.

Then, the code vector index Iₖ may be determined based on determining the remainder of the integer division of the actual single code vector index and the size value Nₖ. For instance, the code vector index Iₖ may represent this remainder.

For instance, with respect to the above mentioned single code vector index based on equation (19), k may be decremented. Then, in order to determine a code vector index from said actual single code vector index, the size of the codebook of the at least one codebook associated with the actual single code vector index which was not multiplied with the code vector index to be determined, wherein this size of the codebook was multiplied with the remaining at least one code vector index associated with the actual single code vector, represents the size Nₖ of codebook Cₖ, because Nₖ is multiplied with each of the code vector indexes I₀ . . . Iₖ₋₁ but is not multiplied with code vector index Iₖ, which represents the code vector index to be determined.

Afterwards, if a further code vector index is to be determined from the actual single code vector index, the actual single code vector index may be updated based on reducing the size of the actual code vector index based on the determined size value. For instance, the actual single code vector index I may be updated by the integer division of the actual single code vector index I and size value, i.e., the updating may be performed by I=int (i/Nₖ). Then, the loop may proceed with the next iteration.

Furthermore, if there is only one code vector index to be extracted from the actual single code vector index, the loop may not proceed with the next determining of a size value, and the last code vector index represents the value of the updated single code vector index.

For instance, with respect to the above mentioned single code vector index based on equation (14), an example of an extracting procedure may be summarized as follows based on a pseudo code:

for k=0:n−2

Iₖ = rem(I,Nₖ)
I = int(I/Nₖ)

end
Iₙ₋₁ = I

Rem represents a function which returns the remainder of the integer division int(I/Nₖ), and k represents an integer which is incremented from 0 to n−2.

For instance, with respect to the above mentioned single code vector index based on equation (19), an example of a decoding procedure may be summarized as follows based on a pseudo code:

for k=n−1:1:−1 (descending order, i.e., k is decremented)

Iₖ = rem(I/ Nₖ)
I = int (I/ Nₖ)

end
I₀ = I

It has to be understood that the loops in these pseudo code examples are not limiting and may be arranged in a different way in order to extract the at least two code vector indexes from the single code vector index.

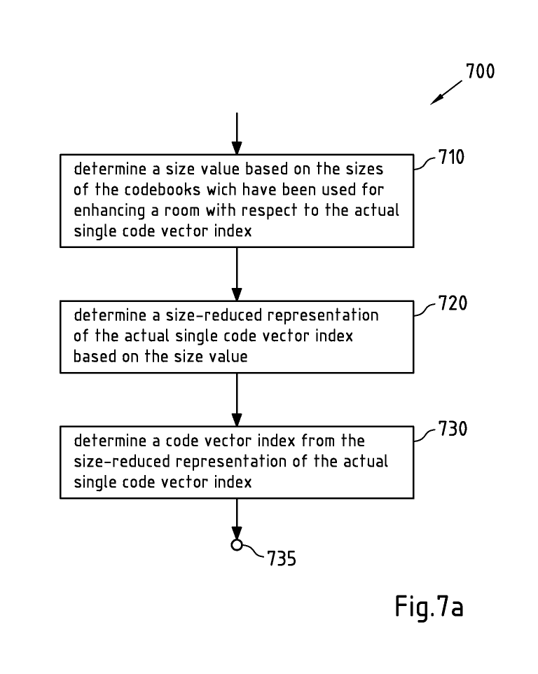

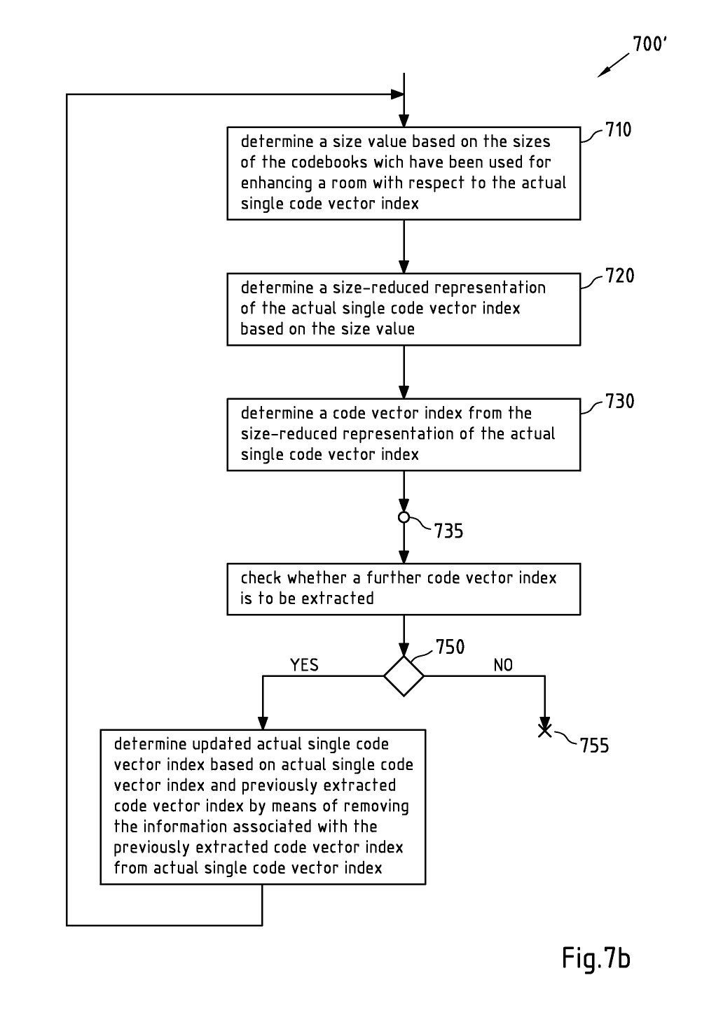

FIG. 7a depicts a flowchart of a method 700 according to an eighth embodiment of the invention, which is based on method 600.

For instance, extracting at least one of the code vector indexes may be performed as follows:

In step 710, a size value based on the sizes of the codebooks which have been used for enhancing the room of a code vector index representation or for enhancing the room with respect to the actual single code vector index is determined, wherein the sizes of the codebooks may represent the sizes of the codebooks which have been used for enhancing the room of a code vector index representation or for enhancing the room of the single code vector index(es). These sizes may be denoted as relevant codebook sizes

Thus, for instance, if equation (14) has been used as a basis for determining the single code vector index, the sizes N₀ . . . Nₙ₋₂₋ₖ of respective codebooks C₀ . . . Cₙ₋₂₋ₖ are determined/obtained. For instance, this may be done based on the information about the respective codebooks of a respective code vector contained in the single code vector index. Or, for instance, if equation (19) has been used as a basis for determining the single code vector index, the sizes N₁₊ₖ . . . Nₙ₋₁ of respective codebooks C₁₊ₖ . . . Cₙ₋₁ are determined/obtained. When step 710 is performed at the first time, k=0 holds, wherein k may represent a loop counter which may be used with respect to the method 700′ according to a ninth embodiment of the invention depicted in FIG. 7b, which is based on method 700 depicted in FIG. 7a.

The size value may represent a multiplication of the sizes of the relevant codebook sizes. This value may be denoted as s. Thus, if equation (14) has been used as a basis for determining the single code vector index, s=N₀ . . . Nₙ₋₂₋ₖ may hold, or, if equation (19) has been used as a basis for determining the single code vector index, the sizes s=N₁₊ₖ . . . Nₙ₋₁ may hold.

Then, in step 720 a size-reduced representation of the actual single code vector index I may be obtained by means of transforming the size of the actual single code vector index to the size-reduced representation based on the sizes of the relevant codebook sizes, i.e., based on s. For instance, this size-reduced representation may be a value r which is obtained based on a division of the single code vector index I and value s. As an example, value r may be represented by r=I/s.

Afterwards, one of the code vector indexes associated with the single code vector index I may be obtained based on the size-reduced representation of the single code vector index, e.g., based on value r. As an example, this code vector index may be determined based on an integer division of I and s, for instance, by or based on truncating the value r. Truncation may be performed by disregarding the digits right to the decimal point. Any other suited mathematical operation may be used to determine one code vector index based on the single code vector index I and value s.

As an example, under the assumption that equation (14) has been used as a basis for determining the single code vector index, and under assumption of a loop index k=0, code vector index Iₙ₋₁₋ₖ may be determined based on the integer division of I and s, i.e., int(I/s). For instance, this integer division may be performed by Iₙ₋₁₋ₖ=trunc(I/s), or it may be performed based on the result of the integer division int(I/s) providing the integer divisor and the remainder or by any other well suited integer division. Thus, for instance, it is not necessary to provide the real number of the division I/s.

Or, as an example, under the assumption that equation (19) has been used as a basis for determining the single code vector index, and under assumption of a loop index k=0, code vector index Iₖ may be determined based on the integer division of I and s, i.e., int(I/s). For instance, this integer division may be performed by Iₖ=trunc(I/s), or it may be performed based on the result of the integer division int (I/s) providing the integer divisor and the remainder or by any other well suited integer division. Thus, for instance, it is not necessary to provide the real number of the division I/s.

This extracted code vector index may denoted as IE.

FIG. 7b depicts a flowchart of a method 700′ according to an ninth embodiment of the invention, which is based on method 700, as indicated be reference sign 735.

In step 740 it is checked whether there is a further code vector index to be extracted. If this checking yields a positive result, an updated actual single code vector index is determined based on the actual single code vector index and the previously extracted code vector index IE by means of removing the information associated with the previously extracted code vector index IE from the single code vector index in step 750.

For instance, said removing the information associated with the previously extracted code vector index IE from the single code vector index may be performed by subtracting a value based on the multiplication of the size value (value s) and the previously extracted code vector index IE from single code vector index:

I=I−s·IE (21)

For instance, the loop counter k may be incremented.

Afterwards, the method proceeds with step 710, where a new a size value s based on the sizes of the codebooks which have been used for enhancing the room of a code vector index representation or for enhancing the room with respect to the actual single code vector index is determined, as explained with respect to method 700 depicted in FIG. 7a.

Thus, for instance, if equation (14) has been used as a basis for determining the single code vector index, the sizes N₀ . . . Nₙ₋₂₋ₖ of respective codebooks C₀ . . . Cₙ₋₂₋ₖ may be determined/obtained. For instance, this may be done based on the information about the respective codebooks of a respective code vector contained in the single code vector index. Or, for instance, if equation (19) has been used as a basis for determining the single code vector index, the sizes Nₖ₊₁ . . . Nₙ₋₁ of respective codebooks C₁₊ₖ . . . Cₙ₋₁ are determined/obtained.

Then, a size-reduced representation of the updated actual single code vector index is determined in step 720, as explained with respect to method 700 depicted in FIG. 7a.

Steps 710 and 720 may be cancelled if the actual single code vector index is only associated with a single one code vector index.

Then, in step 730, one of the code vector indexes associated with the single code vector index I may be obtained based the size-reduced representation of the single code vector index, e.g., based on value r. As an example, this code vector index may be determined based on an integer division of I and s, for instance, by or based on truncating the value r. Truncation may be performed by disregarding the digits right to the decimal point. Any other suited mathematical operation may be used to determine one code vector index based on the single code vector index I and value s. If steps 710 and 720 have been cancelled, the size-reduced representation of the single code vector index represents the actual single code vector index.

As an example, under the assumption that equation (14) has been used as a basis for determining the single code vector index, code vector index Iₙ₋₁₋ₖ may be determined based on the integer division of I and s, i.e., int(I/s). For instance, this integer division may be performed by Iₙ₋₁₋ₖ=trunc(I/s), or it may be performed based on the result of the integer division int(I/s) providing the integer divisor and the remainder or by any other well suited integer division. Thus, for instance, it is not necessary to provide the real number of the division I/s.

Or, as an example, under the assumption that equation (19) has been used as a basis for determining the single code vector index, and under assumption of a loop index k=0, code vector index Iₖ may be determined based on the integer division of I and s, i.e., int(I/s). For instance, this integer division may be performed by Iₖ=trunc(I/s), or it may be performed based on the result of the integer division int (I/s) providing the integer divisor and the remainder or by any other well suited integer division. Thus, for instance, it is not necessary to provide the real number of the division I/s

Thus, by means of this loop depicted in FIG. 7b, the at least two code vector indexes may be extracted from the single code vector index.

The size value may be determined in an iterative way based on the previously determined size value, wherein s=s/Nₙ₋₁₋ₖ may hold with respect to a single code vector index based on equation (14) or wherein s=s/Nₖ may hold with respect to a single code vector index based on equation (19).

In the sequel, a method according to a tenth embodiment of the invention will be presented. This method according to a tenth embodiment of the invention may be based on one or more of the methods according to a seventh, eighth and ninth method of the invention and will presented by means of an C-source example of an implementation:

| | |
|---|---|
| decode_index(uint32 * index, */ | /* (i) - composed |

index

| | |
|---|---|
| int len_index, | /* (i) - length of composed |

index (in number of used 32bit integers)*/

| | |
|---|---|
| int no_cv, | /* (i) - total number of |

| | subvectors, null subvectors |
|---|---|
| | included */ |
| int * idx_cv, | /* (o) - individual codevector |
| | indexes, Ii*/ |
| int * idx_lead) | /* (i) - index of leader class |

(that gives the number of
codevectors for the leader class),
the index is −1 for null
subvectors */

{

int i;
uint32 idx1[4];
for (i=0;i<len_index;i++)
{

idx1[i] = index[i];

}
for(i=0;i<no_cv;i++)
{

```
  if (idx_lead[i] > −1) /* the null subvectors are not taken into
account */
  {
```

len_index = divide_128_32(idx1, len_index,

```
lay_N[idx_lead[i]], idx1, &idx_cv[i]);
  }
  else
  {
```

idx_cv[i] = −1; /* null subvector */

}

}

| } | |
|---|---|
| The division function is given by : | |
| int | |
| divide_128_32(uint32 * x, | /* (i) - input 128 bit |

number (dividend) */

| | |
|---|---|
| int len_x, | /* (i) input array length */ |
| uint32 y, | /* (i) - 32bit divisor */ |
| uint32 * result, | /* (o) - integer quotient */ |
| int * rem) | /* (o) - reminder */ |

{

int len_y = len_x;
int k;
uint64 r, tmp;
r = 0;
for(k=len_x−1; k >=0; k−−)
{

```
  tmp = (uint64)((r<<32)+x[k]);
  result[k] = (uint32) (tmp/y+0.5);
  r = (uint32)(tmp − result[k]*y);
```

}
k = len_x−1;
while ((result[k]==0) &&(k>=0))
{

```
  len_y−−;
  k−−;
```

}
return len_y;

}

The number of code vectors for each possible leader class is given by the array lay_N.

As a non-limiting example, the number of codevectors for each possible leader class may be given by the following array lay_N:
int lay_N[ ]=1180, 512, 3360, 5120, 2880, 23040, 13440, 40320, 61440, 20, 107520, 11520, 107520, 46080, 20160, 201600, 184320, 5120, 430080, 129024, 322560, 360, 13440, 180, 46080, 537600, 80640, 645120, 184320, 161280, 5760, 645120};

The corresponding integer number of bits for each leader class is given by lay_no_bits.
int lay_no_bits[ ]=
/* fixed rate per leader */
{8, 9, 12, 13, 12, 15, 14, 16, 16, 5, 17, 14, 17, 16, 15, 18, 18, 13, 19, 17, 19, 9, 14, 8, 16, 20, 17, 20, 18, 18, 13, 20, 16, 17, 20, 20, 17, 10, 20, 21, 19, 21, 15, 20, 17, 18, 16, 21, 13, 22, 19, 16, 10, 18, 23, 16, 19, 21, 22, 21, 15, 18};

When using the composed index the number of bits for each leader class is given by the floating point numbers from lay_no_bits_flt, out of which the bitrate savings can clearly be seen:
float lay_no_bits_flt[ ]={7.4919, 9.0000, 11.7142, 12.3219, 11.4919, 14.4919, 13.7142, 15.2992, 15.9069, 4.3219, 16.7142, 13.4919, 16.7142, 15.4919, 14.2992, 17.6211, 17.4919, 12.3219, 18.7142, 16.9773, 18.2992, 8.4919, 13.7142, 7.4919, 15.4919, 19.0362, 16.2992, 19.2992, 17.4919, 17.2992, 12.4919, 19.2992};

As used in this application, the term ‘circuitry’ refers to all of the following:

(a) hardware-only circuit implementations (such as implementations in only analog and/or digital circuitry) and

(b) combinations of circuits and software (and/or firmware), such as (as applicable):

(i) to a combination of processor(s) or

(ii) to portions of processor (s)/software (including digital signal processor(s)), software, and memory(ies) that work together to cause an apparatus, such as a mobile phone or a positioning device, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a positioning device.

With respect to the aspects of the invention and their embodiments described in this application, it is understood that a disclosure of any action or step shall be understood as a disclosure of a corresponding (functional) configuration of a corresponding apparatus (for instance a configuration of the computer program code and/or the processor and/or some other means of the corresponding apparatus), of a corresponding computer program code defined to cause such an action or step when executed and/or of a corresponding (functional) configuration of a system (or parts thereof).

The aspects of the invention and their embodiments presented in this application and also their single features shall also be understood to be disclosed in all possible combinations with each other. It should also be understood that the sequence of method steps in the flowcharts presented above is not mandatory, also alternative sequences may be possible.

The invention has been described above by non-limiting examples. In particular, it should be noted that there are alternative ways and variations which are obvious to a skilled person in the art and can be implemented without deviating from the scope and spirit of the appended claims.

1-43. (canceled)

44. An apparatus, comprising at least one processor; and at least one memory including computer program code, said at least one memory and said computer program code configured to, with said at least one processor, cause said apparatus at least to determine a single code vector index based on combining at least two code vector indexes, each code vector index being associated with a code vector of a respective codebook.

45. The apparatus according to claim 44, wherein said single code vector index is associated with a combined code vector of a combined codebook, and wherein said combined code vector comprises information on the at least two code vectors and said combined codebook is based on a combination of the codebooks associated with the at least two code vector indexes.

46. The apparatus according to claim 44, further caused to split at least one vector into at least two subvectors and to encode on each of at least two of the at least two subvectors, wherein said apparatus caused to encode comprises for each of at least two subvectors of the at least two subvectors:
determine a codebook of at least two codebooks, each of the at least two codebook being associated with a respective leader class and comprising at least one code vector;
determine a code vector in the respective codebook; and
provide a code vector index of the determined code vector, the provided code vector index being one of the at least two code vector indexes.

47. The apparatus according to one of claim 44, further caused to:
assign a first code vector index of the at least two code vector indexes to the single code vector index;
select a further code vector index of the at least two code vector indexes;
map the selected code vector index to an enhanced code vector index representation, said enhanced code vector index representation taking into account the at least one codebook being associated with the actual single code vector index; and
update the single code vector index by combining the single code vector index with the enhanced code vector index representation.

48. The apparatus according to claim 47, wherein the enhanced code vector index representation is associated with an enhanced room of a size depending on the size of the codebook of the selected code vector index and on the size of each of the at least one codebook being associated with the actual single code vector index.

49. The apparatus according to claim 47, wherein said apparatus caused to mapp the selected code vector index to an enhanced code vector index representation is based on a multiplication of the selected code vector index and a value depending on the size of each of the at least one codebook being associated with the actual single code vector index.

50. The apparatus according to claim 44, further caused to:
assign a first code vector index of the at least two code vector indexes to the single code vector index;
select a further code vector index of the at least two code vector indexes;
transform the single code vector index to a representation being associated with an enhanced room of a size depending on the size of the codebook of the selected code vector index and on the size of each of the at least one codebook being associated with the actual single code vector index; and
update the single code vector index by combining the transformed single code vector index with the selected code vector index.

51. The apparatus according to claim 50, wherein said apparatus caused to transform the single code vector representation is based on a multiplication of the actual single code vector index and a value depending on the size the codebook being associated with the selected code vector index.

52. The apparatus according to claim 47, further caused to, after the updating, to check whether there is a further code vector index of the at least two code vector indexes, and, if this check yields a positive result, to select this further code vector index and proceed with said mapp/transform and update.

53. An apparatus, comprising at least one processor; and at least one memory including computer program code, said at least one memory and said computer program code caused to, with said at least one processor, cause said apparatus at least to perform extracting at least one code vector index from a single code vector index, wherein the single code vector index single code vector index is based on a combination of at least two code vector indexes, each code vector index being associated with a code vector of a respective codebook.

54. The apparatus according to claim 53, further caused to:
determine a size value based on the size of one of the at least one codebook which has been used for enhancing a room with respect to the actual single code vector index;
determine a code vector index based on determining the remainder of an integer division of the actual single code vector index and the size value; and
update the actual single code vector index by reducing the size of the single code vector index based on the size value.

55. The apparatus according to claim 54, further caused to, after determining a code vector index, to check whether there is a further code vector index to be extracted, and, if this check yields a positive result, to proceed with determining a size value based on the size of one of the at least one codebook which has been used for enhancing a room with respect to the actual single code vector index, to determine a code vector index based on determining the remainder of an integer division of the actual single code vector index and the size value and to update the actual single code vector.

56. The apparatus according to claim 55, further caused to:
determine a size value based on the sizes of the codebooks which have been used for enhancing a room with respect to the actual single code vector index;
determine a size-reduced representation of the actual single code vector index based on the size value; and
determine a code vector index from the size-reduced representation of the actual single code vector index.

57. The apparatus according to claim 56, further caused to, after determining a code vector index, to check whether there is a further code vector index to be extracted, and, if this checking yields a positive result, to determine an updated actual single code vector index based on the actual single code vector index and the previously determined code vector index by means of removing the information associated with the previously determined extracted code vector index from the actual single code vector index and to proceed with said determining a size value, determining a size-reduced representation of the actual single code vector index, if necessary, and with determining a code vector index.

58. A Method comprising:
determining a single code vector index based on combining at least two code vector indexes, each code vector index being associated with a code vector of a respective codebook.

59. The method according to claim 58, wherein said combining comprises:
assigning a first code vector index of the at least two code vector indexes to the single code vector index;
selecting a further code vector index of the at least two code vector indexes;
mapping the selected code vector index to an enhanced code vector index representation, said enhanced code vector index representation taking into account the at least one codebook being associated with the actual single code vector index; and
updating the single code vector index by combining the single code vector index with the enhanced code vector index representation.

60. The method according to claim 59, wherein the enhanced code vector index representation is associated with an enhanced room of a size depending on the size of the codebook of the selected code vector index and on the size of each of the at least one codebook being associated with the actual single code vector index.

61. The method according to claim 58, wherein said combining comprises:
assigning a first code vector index of the at least two code vector indexes to the single code vector index;
selecting a further code vector index of the at least two code vector indexes;
transforming the single code vector index to a representation being associated with an enhanced room of a size depending on the size of the codebook of the selected code vector index and on the size of each of the at least one codebook being associated with the actual single code vector index; and
updating the single code vector index by combining the transformed single code vector index with the selected code vector index.

62. The method according to claim 61, wherein said transforming the single code vector representation is based on a multiplication of the actual single code vector index and a value depending on the size the codebook being associated with the selected code vector index.

63. A method comprising:
extracting at least one code vector index from a single code vector index, wherein the single code vector index single code vector index is based on a combination of at least two code vector indexes, each code vector index being associated with a code vector of a respective codebook.
